(19) United States
(12) Patent Application Publication
(10) Pub. No.: US 2010/0158561 A1
(43) Pub. Date: Jun. 24, 2010

(54) ELECTROPHOTOGRAPHIC PHOTOSENSITIVE BODY, METHOD FOR PRODUCING CONDUCTIVE BASE, IMAGE FORMING DEVICE, AND ELECTROPHOTOGRAPHIC CARTRIDGE

(75) Inventors: Teruyuki Mitsumori, Kanagawa (JP); Kozo Ishio, Kanagawa (JP); Hiroe Fuchigami, Kanagawa (JP); Susumu Taguchi, Kanagawa (JP); Shunichiro Kurihara, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI CHEMICAL CORPORATION, Minato-ku (JP)

(21) Appl. No.: 12/300,943

(22) PCT Filed: May 18, 2007
(86) PCT No.: PCT/JP2007/060219

§ 371 Date: Mar. 18, 2009

(30) Foreign Application Priority Data
May 18, 2006 (JP) 2006-139528

(51) Int. Cl. G03G 21/16; G03G 5/14; G03G 15/00

(52) U.S. Cl. 399/111; 430/60; 430/127; 399/159

(57) ABSTRACT

An electrophotographic photoreceptor having high performance that hardly generates image defects such as black spots, color spots, and interference fringes is provided. The electrophotographic photoreceptor includes an undercoat layer containing metal oxide particles and a binder resin on an electroconductive substrate having a maximum height surface roughness Rz in the range of 0.8≦Rz≦2 μm, and a photosensitive layer disposed on the undercoat layer, wherein the metal oxide particles have a volume average particle diameter of 0.1 μm or less and a 90% cumulative particle diameter of 0.3 μm or less which are measured by a dynamic light-scattering method in a liquid containing the undercoat layer dispersed in a solvent mixture of methanol and 1-propanol at a weight ratio of 7:3.

### TECHNICAL FIELD

The present invention relates to an electrophotographic photoreceptor, a process of producing an electroconductive substrate to be used in the photoreceptor, and an image-forming apparatus and an electrophotographic cartridge that include the photoreceptor.

### BACKGROUND ART

Electrophotographic technology has been widely applied to the field of various printers, recently, as well as the field of copiers, due to its immediacy and formation of high-quality images. Electrophotographic photoreceptors (hereinafter, optionally, referred to as “photoreceptor”) lie in the core technology of electrophotography, and organic photoreceptors using organic photoconductive materials have been developed, since they have advantages such as non-pollution and ease in production in comparison with inorganic photoconductive materials.

In general, an organic photoreceptor is composed of an electroconductive substrate and a photosensitive layer disposed thereon. Photoreceptors are classified into a so-called single-layer photoreceptor having a single photosensitive layer (single photosensitive layer) containing a binder resin dissolving or dispersing a photoconductive material therein; and a so-called multilayered photoreceptor composed of a plurality of laminated layers (laminated photosensitive layer) including a charge-generating layer containing a charge-generating material and a charge-transporting layer containing a charge-transporting material.

In the organic photoreceptor, changes in use environment of the photoreceptor or changes in electric characteristics during repeated use may cause various defects in an image formed with the photoreceptor. In a method as one technique for solving such disadvantages, an undercoat layer containing a binder resin and titanium oxide particles is provided between an electroconductive substrate and a photosensitive layer in order to stably form a good image (for example, refer to Patent Document 1).

The layer of the organic photoreceptor is generally formed by applying and drying a coating liquid prepared by dissolving or dispersing a material in a solvent, because of its high productivity. In such a case, since the titanium oxide particles and the binder resin contained in the undercoat layer are incompatible with each other in the undercoat layer, the coating liquid for forming the undercoat layer is provided in the form of a dispersion of titanium oxide particles.

Such a coating liquid has generally been produced by wet-dispersing titanium oxide particles in an organic solvent using a known mechanical pulverizer, such as a ball mill, a sand grind mill, a planetary mill, or a roll mill, by spending a long period of time (for example, refer to Patent Document 1). Furthermore, it is disclosed that when titanium oxide particles are dispersed in a coating liquid for forming an undercoat layer using a dispersion medium, an electrophotographic photoreceptor that exhibits excellent characteristics in repeated charging-exposure cycles even under conditions of low temperature and low humidity can be provided using titania or zirconia as the dispersion medium (for example, refer to Patent Document 2).

In general, the titanium oxide particles are aggregated into secondary particles, and it is known that image defects such as black spots and color spots can be suppressed by dispersing the particles in a state similar to primary particles.

However, an image formed with a photoreceptor has unevenness, a so-called interference fringe, as one of the image defects. This phenomenon occurs by the following mechanism: Writing light beams from a laser or a light-emitting diode (LED) are reflected and interfere at a substrate surface or a coating interface of an electrophotographic photoreceptor due to a slight difference in thickness. This causes unevenness in intensity of light that affects a charge-generating layer, resulting in irregular sensitivities at different positions over the area.

The interference-fringe defect can be effectively prevented by roughening the substrate surface, and various roughening processes are reported (Patent Documents 3 to 9).

[Patent Document 1] Japanese Unexamined Patent Application Publication No. HEI 11-202519

[Patent Document 2] Japanese Unexamined Patent Application Publication No. HEI 6-273962

[Patent Document 3] Japanese Unexamined Patent Application Publication No. 2000-105481

[Patent Document 4] Japanese Unexamined Patent Application Publication No. HEI 6-138683

[Patent Document 5] Japanese Unexamined Patent Application Publication No. 2001-296679

[Patent Document 6] Japanese Unexamined Patent Application Publication No. HEI 5-224437

[Patent Document 7] Japanese Unexamined Patent Application Publication No. HEI 8-248660

[Patent Document 8] Japanese Unexamined Patent Application Publication No. HEI 6-138683

[Patent Document 9] Japanese Unexamined Patent Application Publication No. HEI 1-123246

### DISCLOSURE OF INVENTION

### Problems to be Solved by the Invention

However, a higher roughness of a substrate surface may adversely affect uniformity in thickness of a coating disposed on the substrate or may cause burrs on the substrate or form locally thin areas in the coating. This causes image defects such as black spots, black lines, and color spots.

Metal oxide particles of, for example, titanium oxide dispersed in an undercoat layer scatter writing light beams from, for example, a laser or an LED, thereby suppressing interference fringes. However, in the case that the metal oxide particles are dispersed in a state similar to primary particles in order to reduce image defects such as black spots and color spots, the effect of the undercoat layer for suppressing interference fringes is suppressed, resulting in increased interference fringes on an image. Furthermore, a significantly roughened substrate surface for reducing interference fringes increases image defects, such as black spots, color spots, and black lines.

Thus, the performance is still insufficient in many points from the view of decreasing all these image defects in a balanced manner.

The present invention has been made in view of such background of an electrophotographic technology. It is an object to provide an electrophotographic photoreceptor having high performance that hardly generates image defects such as black spots, color spots, and interference fringes, a process of producing an electroconductive substrate to be used in the electrophotographic photoreceptor, and an image-forming apparatus and an electrophotographic cartridge that include the photoreceptor.

### Means for Solving the Problems

The present inventors have conducted intensive studies for solving the above-mentioned problems and, as a result, have found the fact that satisfactory electric characteristics for forming a high-quality image substantially not having image defects, such as black spots and color spots, under various use environments can be achieved by controlling the particle size of titanium oxide particles in an undercoat layer within a specific range and also the high-quality image hardly generates interference fringes when an electroconductive substrate having a surface roughness within a specific range is used. The present invention has been thus accomplished.

Accordingly, an aspect of the present invention relates to an electrophotographic photoreceptor including an undercoat layer containing metal oxide particles and a binder resin on an electroconductive substrate having a maximum height surface roughness Rz in the range of 0.8≦Rz≦2 μm, and a photosensitive layer disposed on the undercoat layer. The metal oxide particles have a volume average particle diameter of 0.1 μm or less and a 90% cumulative particle diameter of 0.3 μm or less which are measured by a dynamic light-scattering method in a liquid containing the undercoat layer dispersed in a solvent mixture of methanol and 1-propanol at a weight ratio of 7:3 (claim 1).

The surface profile of the electroconductive substrate is preferably formed by a cutting process (claim 2).

Furthermore, micro-grooves preferably formed on the surface of the electroconductive substrate, the grooves preferably being curved and discontinuous in a developed plan view of the electroconductive substrate surface (claim 3).

The grooves formed on the surface of the electroconductive substrate preferably are in a grid pattern (claim 4).

The kurtosis Rku of the surface of the electroconductive substrate is preferably in the range of 3.5≦Rku≦25, and the width L of the grooves formed on the surface of the electroconductive substrate is preferably in the range of 0.5≦L≦6.0 μm (claim 5).

Another aspect of the present invention relates to a process of producing an electroconductive substrate of the electrophotographic photoreceptor. The process of producing the electroconductive substrate includes steps of bringing a flexible material into contact with a surface of the electroconductive substrate and moving the material relative to the electroconductive substrate surface (claim 6).

Preferably, the surface of the electroconductive substrate is processed in advance by any processing of cutting, ironing, grinding, and honing (claims 7 to 10).

Furthermore, the flexible material is preferably a brush (claim 11) and a brush preferably comprises a resin containing abrasive grains kneaded therein (claim 12).

Still another aspect of the present invention relates to an image-forming apparatus including the electrophotographic photoreceptor, charging means for charging the electrophotographic photoreceptor, image exposing means for forming an electrostatic latent image by conducting image exposure to the charged electrophotographic photoreceptor, development means for developing the electrostatic latent image with toner, and transfer means for transferring the toner to a transfer object (claim 13).

Further another aspect of the present invention lies in an electrophotographic cartridge including the electrophotographic photoreceptor and at least one means selected from charging means for charging the electrophotographic photoreceptor, image exposing means for forming an electrostatic latent image by conducting image exposure to the charged electrophotographic photoreceptor, development means for developing the electrostatic latent image with toner, transfer means for transferring the toner to a transfer object, fixing means for fixing the toner transferred to the transfer object, and cleaning means for recovering the toner adhering to the electrophotographic photoreceptor (claim 14).

### Advantageous effects of the Invention

The present invention can provide an electrophotographic photoreceptor achieving high performance that hardly generates image defects such as black spots, color spots, and interference fringes, a process of producing an electroconductive substrate to be used in the electrophotographic photoreceptor, and an image-forming apparatus and an electrophotographic cartridge that include the photoreceptor.

### BRIEF DESCRIPTION OF DRAWINGS

FIG. 1 is a schematic view illustrating an exemplary process of roughening an electroconductive substrate according to the present invention;

FIG. 2 is a schematic plan view illustrating an exemplary groove shape on the surface of an electroconductive substrate according to the present invention;

FIG. 3 is a schematic plan view illustrating an exemplary groove shape on the surface of an electroconductive substrate according to the present invention;

FIG. 4 is a schematic view illustrating an exemplary process of producing an electroconductive substrate according to the present invention;

FIG. 5 is a schematic view illustrating an exemplary process of producing an electroconductive substrate according to the present invention;

FIG. 6 is a schematic view illustrating an exemplary process of producing an electroconductive substrate according to the present invention;

FIG. 7 is a longitudinal cross-sectional view schematically illustrating a structure of a wet agitating ball mill according to an embodiment of the present invention;

FIG. 8 is an enlarged longitudinal cross-sectional view schematically illustrating a mechanical seal used in a wet agitating ball mill according to an embodiment of the present invention;

FIG. 9 is a longitudinal cross-sectional view schematically illustrating a wet agitating ball mill according to another embodiment of the present invention;

FIG. 10 is a horizontal cross-sectional view schematically illustrating a separator of the wet agitating ball mill shown in FIG. 9;

FIG. 11 is a schematic view illustrating the main structure of an embodiment of an image-forming apparatus provided with an electrophotographic photoreceptor of the present invention; and

FIG. 12 is a powder X-ray diffraction spectrum pattern of oxytitanium phthalocyanine used as a charge-generating material in Examples and Comparative Examples of the present invention, to CuKα characteristic X-rays.

### REFERENCE NUMERALS

1 electroconductive substrate

1A axis of electroconductive substrate

2 internal expanding holding mechanism

3 wheel-shaped brush

3A axis of wheel-shaped brush

4 cup-shaped brush

4A axis of cup-shaped brush

5 washing brush

14 separator

15 shaft

16 jacket

17 stator

19 discharging path

21 rotor

24 pulley

25 rotary joint

26 raw slurry supplying port

27 screen support

28 screen

29 product slurry retrieval port

31 disk

32 blade

35 valve element

100 sealing

101 mating ring

102 spring

103 fitting groove

104 O-ring

105 shaft

106 separator

107 spacer

108 rotor

109 stopper

110 screw

111 discharging path

112 pore

113 spacer

114 blade fitting groove

115 disk

116 blade

201 photoreceptor

202 charging device (charging roller)

203 exposure device

204 development device

205 transfer device

206 cleaning device

207 fixing device

241 development vessel

242 agitator

243 supply roller

244 development roller

245 regulation member

271 upper fixing member (fixing roller)

272 lower fixing member (fixing roller)

273 heating device

T toner

P transfer material (paper, medium)

### BEST MODES FOR CARRYING OUT THE INVENTION

Embodiments of the present invention will now be described in detail, but the description of components below is merely exemplary embodiments of the present invention. Accordingly, various modifications can be made within the scope of the present invention.

An electrophotographic photoreceptor of the present invention includes an undercoat layer containing metal oxide particles and a binder resin on an electroconductive substrate, and a photosensitive layer disposed on the undercoat layer. Furthermore, in the electrophotographic photoreceptor of the present invention, the electroconductive substrate has a predetermined surface roughness, and the metal oxide particles contained in the undercoat layer have a predetermined particle diameter distribution.

### [I. Electroconductive Substrate]

### [I-1. Surface Roughness of Electroconductive Substrate]

The electroconductive substrate according to the present invention has a maximum height surface roughness Rz within a predetermined range, thereby preventing an interference fringe defect. Specifically, the maximum height surface roughness Rz of the electroconductive substrate according to the present invention is usually 0.8 μm or more, preferably 1.0 μm or more, and more preferably 1.1 μm or more and usually 2 μm or less, preferably 1.8 μm or less, and more preferably 1.6 μm or less. A smaller maximum height surface roughness Rz may insufficiently scatter reflected light beams, and a larger roughness may readily cause image defects such as black spots. The maximum height surface roughness Rz is defined in JIS B 0601:2001. Here, the term “surface of an electroconductive substrate” denotes at least a part of the surface of an electroconductive substrate and usually denotes the image-forming region of the electroconductive substrate.

The electroconductive substrate according to the present invention may have any surface profile that has a maximum height surface roughness Rz within the above-mentioned range. In addition, the surface of the electroconductive substrate may be roughened by any method.

For example, grooves may be formed in the direction substantially orthogonal to the axis of the electroconductive substrate. Such grooves are formed by cutting, in many cases. However, in such a case, the reflected light beams of writing light to a photoreceptor are scattered in a particular plane parallel to the substrate axis. Accordingly, the suppression of interference fringes may be insufficient.

Therefore, in the roughening of a surface of the electroconductive substrate according to the present invention, micro-grooves that have curved and discontinuous shapes (hereinafter, optionally, referred to as “arc-shaped grooves”) are preferably formed on the surface of the electroconductive substrate, in a developed plan view of the surface of the electroconductive substrate. Here, the phrase “curved and discontinuous shapes in a developed plan view of the surface of the electroconductive substrate” means the shapes that are obtained by projecting grooves observed on the surface of the electroconductive substrate onto a plane. The micro-grooves having such shapes have openings on the surface of the substrate and are substantially curved and discontinuous in the face direction parallel to the substrate surface, though the depth thereof varies, for example. The use of the electroconductive substrate having a rough surface containing the arc-shaped grooves disturbs the regularity of reflected light beams from the electroconductive substrate surface, thereby disturbing interferences between reflected light beams from the interfaces of coatings (i.e., undercoat layer and photosensitive layer). As a result, the effect of suppressing interference fringes can be enhanced. In the case that the surface of the electroconductive substrate is roughened by forming linear grooves, the reflected light beams are scattered by the grooves in a direction with a specific angle. However, the curved grooves, such as arc-shaped grooves, slightly change the directions of reflected light beams scattered thereby. Furthermore, the discontinuousness of grooves changes the directions of reflected light beams from seams of the grooves. Therefore, the reflected light beams from the electroconductive substrate surface are scattered into various directions by roughening the surface with arc-shaped grooves, thereby enhancing the effect of suppressing interference fringes.

The arc-shaped grooves are preferably formed into a grid pattern. That is, a surface of the electroconductive substrate is usually provided with a large number of arc-shaped grooves, and these arc-shaped grooves form a groove pattern on the surface of the electroconductive substrate. This groove pattern is preferably a grid pattern. As a result, irregularity of the surface profile of the electroconductive substrate is further increased, thereby reliably preventing interference fringes.

The indices representing the surface roughness of the electroconductive substrate according to the present invention do not have any limitation as long as the maximum height surface roughness Rz is satisfied, but preferably satisfy the following conditions:

The kurtosis Rku of the surface of the electroconductive substrate according to the present invention is usually 3.5 or more, preferably 4.2 or more, and more preferably 4.5 or more and usually 25 or less, preferably 15 or less, and more preferably 9 or less. The kurtosis Rku indicates the sharpness of a roughness distribution waveform. By controlling this kurtosis Rku within the above-mentioned range, image defects in an image formed can be prevented, and the productivity of electroconductive substrate can be practically improved. The kurtosis Rku can be measured by the method defined in JIS B 0601:2001.

The kurtosis Rku value of nondense arc-shaped grooves is large and tends to become smaller with an increase in roughness of the surface of the electroconductive substrate. Though it slightly depends on the processing step, in general, the kurtosis Rku gradually decreases with the progress of roughening and converges to a value near 3. For example, in roughening by honing or blasting, the kurtosis Rku is usually between about 2.5 and 3 in many cases. Roughening by cutting brings about serrations usually having a kurtosis Rku of about 2 to 3 in many cases.

In the case that the arc-shaped grooves are formed, the width L of the arc-shaped grooves is usually 0.5 μm or more, preferably 0.6 μm or more, and more preferably 0.7 μm or more and usually 6.0 μm or less, preferably 4.0 μm or less, and more preferably 3.0 μm or less. A smaller groove width L may decrease the productivity of the electroconductive substrate. In the case that the groove width L is large, the depth of irregularities on the surface of the electroconductive substrate is also increased, and image defects such as black lines may be caused in an image formed.

The groove width L can be determined as the arithmetic mean value of groove widths at 100 points in total by measuring the groove widths of any 5 points in each of any 20 grooves of the electroconductive substrate surface by observation under an optical microscope at 400 times magnification.

In particular, the electroconductive substrate according to the present invention preferably has a maximum height surface roughness Rz, a kurtosis Rku, and a groove width L within the above-mentioned ranges. That is, a particularly preferred electroconductive substrate of the present invention has a maximum height surface roughness Rz in the range of 0.8≦Rz≦2 μm, a kurtosis Rku of 3.5≦Rku≦25, and grooves formed on the surface having a width L of 0.5≦L≦6.0 μm.

### [I-2. Configuration of Electroconductive Substrate]

The electroconductive substrate of the present invention may be any one that is employed in known electrophotographic photoreceptors, and examples thereof include drums made of metal materials such as aluminum, stainless steel, copper, or nickel; sheets made of the metals; laminates of foils of these metals; materials deposited with these metals; and insulating substrates, such as polyester films and paper, having electroconductive layers made of, for example, aluminum, copper, palladium, tin oxide, or indium oxide, on the surfaces thereof. Other examples of the electroconductive substrate include plastic films, plastic drums, papers, and paper tubes that are electroconductively treated by applying an electroconductive material, such as metal powder, carbon black, copper iodide, or a polymer electrolyte, together with a suitable binder resin. Furthermore, other examples of the electroconductive substrate include plastic sheets and drums that are electroconductive by containing electroconductive materials such as metal powder, carbon black, or carbon fiber; and plastic films and belts that are electroconductively treated with electroconductive metal oxides such as tin oxide or indium oxide.

Among them, an endless pipe made of a metal such as aluminum is preferable. In particular, an endless pipe made of aluminum or an aluminum alloy (hereinafter, optionally, collectively referred to as “aluminum”) can be preferably used as the electroconductive substrate according to the present invention.

### [I-3. Process of Producing Electroconductive Substrate]

The electroconductive substrate according to the present invention may be produced by any process for roughening the electroconductive substrate.

The roughening is generally performed by, for example, forming a surface profile of the electroconductive substrate by cutting with, for example, a lathe for forming irregularity on the surface of the electroconductive substrate. The above-mentioned maximum height surface roughness Rz can be realized by the cutting.

In roughening performed by cutting, a slight difference in the surface roughness may cause generation of interference fringes. Accordingly, in the roughening by cutting, careful attention must be paid for the maintaining of cutting conditions. In a usual cutting process, as described above, continuous grooves having high regularity are formed in the direction substantially perpendicular to the substrate axis in many cases.

In the process of producing the electroconductive substrate according to the present invention, the roughening is preferably performed by bringing a flexible material into contact with the electroconductive substrate surface and moving the material relative to the electroconductive substrate surface. This roughening process will now be described.

First, an electroconductive substrate to be roughened is prepared. As described above, any electroconductive substrate can be used, but particularly preferred is an endless pipe of aluminum or an aluminum alloy.

The endless pipe may also be formed by any process. Known formation processes are, for example, extrusion, drawing, cutting, and ironing, and, in many cases, the final endless pipe is formed by a combination of a plurality of these processes. In usual, cutting or ironing is performed as the final process. In particular, the ironing is preferable due to high productivity. The formation of an electroconductive substrate by ironing can significantly reduce the production time of the electroconductive substrate compared to that in cutting.

An aluminum endless pipe formed by a usual process described above can be directly used. However, in order to satisfy mechanical accuracy required as an electroconductive photoreceptor, the electroconductive substrate is preferably prepared by forming irregularity on a surface thereof to some extent by at least one process (preliminary process), such as ironing, cutting, grinding, or honing, prior to the process for roughening and then processing the surface so as to have a predetermined surface roughness (the above-mentioned maximum height surface roughness Rz).

In addition, in the case that an electroconductive substrate other than aluminum endless pipes is used, it is preferable that the preliminary process be conducted for preliminarily forming some irregularities on a surface of the electroconductive substrate and then arc-shaped grooves be formed. Such a preliminary process improves productivity of the electroconductive substrate. That is, since continuous or discontinuous grooves extending, for example, in the axis and circumferential directions can be formed on the surface of the electroconductive substrate depending on the type of the preliminary process, the surface profile of the electroconductive substrate can have a higher irregularity than that of the case that only arc-shaped grooves are formed. Accordingly, the effect of suppressing interference fringes can be further enhanced.

Among the processes for forming the electroconductive substrate, the formation process such as ironing or cutting also functions as the preliminary process.

After the preparation of the electroconductive substrate, a flexible material serving as a rubbing material is brought into contact with the surface of the electroconductive substrate and is moved relative to the surface to form arc-shaped grooves. Since the rubbing material is deformed at the contact portion, the rubbing speed is changed during the period from the start to the end of the contact. Consequently, the grooves have curved shapes. In an electroconductive substrate having a curved surface that is generally used, the groove shapes become curves when the rotation axes of the electroconductive substrate and the rubbing material are not parallel to each other. That is, the arc-shaped grooves according to the present invention are formed when the positional relation between the rotation axes of the electroconductive substrate and the rubbing material is not parallel.

Examples of the flexible material include rubber, but are not limited thereto, resins, sponge, brushes, clothes, and nonwoven fabrics. Furthermore, these flexible materials preferably contain abrasive grains in order to increase the efficiency of forming the arc-shaped grooves. In particular, a brush made of a resin containing abrasive grains kneaded therein is further preferable.

Use of a rubbing material that does not practically have flexibility, such as a grindstone, causes formation of deep dents at some portions of the surface of the electroconductive substrate, which is undesirable. Shallow grooves can be formed using fine abrasive grains, but in such a case, not only the productivity decreases, but also the abrasive grains may clog. In the case that the electroconductive substrate is aluminum or an alloy thereof, clogged grinding powder tends to be transferred to the surface of soft aluminum or an alloy thereof, thereby readily causing a foreign matter defect. Since the grindstone is not substantially deformed at the contact portion, the grooves have short and linear shapes in many cases.

The brush to be used is preferably made of a resin, such as nylon, containing abrasive grains kneaded therein. A grinding brush generally used mainly contains the grinding power at the tips of the brush material (so-called “brush hair”), and the brush containing abrasive grains can effectively utilize the body portion of the brush material for grinding. Therefore, the contact area can be enlarged to increase the productivity, and also the elasticity of the brush enables moderate grinding not to form excessive irregularity and to suppress the amount removed. In addition, the brush material has flexibility and the contact portion continuously changes, thereby hardly causing clogging. By utilizing these characteristics, it is possible to use abrasive grains having a small size, which cannot be used in grinding as a grindstone because of occurrence of clogging. Thus, the surface roughness can be readily controlled to be low. This is also highly effective on image defects other than interference fringes. Furthermore, since the irregularity of the formed arc-shaped grooves is high, interference fringes can be effectively suppressed.

The above-mentioned maximum height surface roughness Rz, kurtosis Rku, and groove width L can be controlled by physical properties of the brush material, such as the length, hardness, implantation density, and diameter of abrasive grains kneaded in the brush; and treatment conditions such as the rotation speed of the brush and the time for abutting the brush to the electroconductive substrate.

Among them, the maximum height surface roughness Rz is particularly affected by diameter of the abrasive grains kneaded in the brush. There is a tendency that the Rz increases with the abrasive grain diameter, and Rz decreases with the abrasive grain diameter. Accordingly, the diameter of the abrasive grains is usually 1 μm or more and preferably 5 μm or more and usually 50 μm or less and preferably 35 μm or less.

The kurtosis Rku relates to the frequency of contact of the brush with the electroconductive substrate and particularly varies depending on the rotation speed of the brush, the treatment time of the electroconductive substrate with the brush, and the frequency of roughening treatment with the brush. In general, the kurtosis Rku is large at the beginning of the treatment and decreases with the progress of the treatment. Accordingly, an electroconductive substrate having desired arc-shaped grooves can be obtained by measuring the kurtosis Rku during the treatment and terminating the treatment when the kurtosis Rku reaches a value within the above-mentioned range.

Furthermore, the conditions for roughening treatment may be constant or may be changed. In particular, arc-shaped grooves can be formed in a grid pattern by conducting a plurality of times of treatment under different conditions.

It is generally known that micro-burrs occur in the case that irregularity is formed on a surface of the electroconductive substrate by cutting, grinding, or honing. When an undercoat layer or a photosensitive layer is formed on the electroconductive substrate, the burrs form locally thin portions in the undercoat layer and the photosensitive layer, resulting in image defects such as black spots, color spots, and black lines in many cases. However, the burrs on the electroconductive substrate surface can be removed by, as described above, bringing a rubbing material of a flexible material into contact with the surface of the electroconductive substrate and moving the rubbing material relative to the electroconductive substrate. Consequently, in the roughening process of the electroconductive substrate of the present invention, the advantage that the quality of the finally obtained electroconductive substrate is not decreased, even if burrs occur during the preliminary process, can be achieved.

An exemplary roughening process will now be described in more detail.

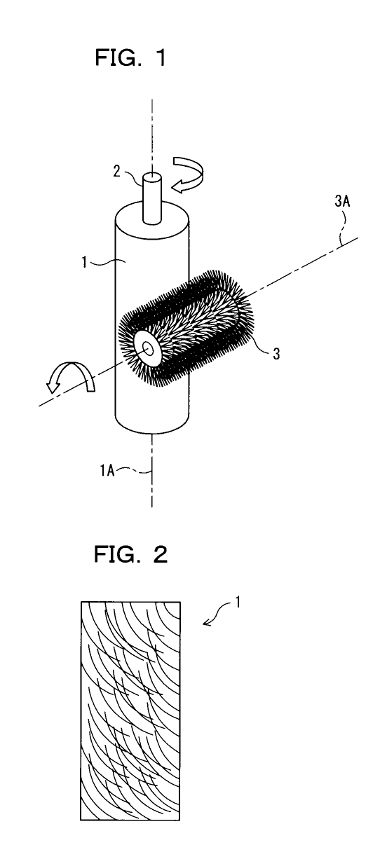

FIG. 1 is a schematic view for illustrating such an exemplary process of roughening an electroconductive substrate. An electroconductive substrate 1 is rotatably held by an internal expanding holding mechanism 2 and turns around the axis (hereinafter, optionally, referred to as “substrate axis”) 1A with the rotation of the internal expanding holding mechanism 2.

A wheel-shaped brush 3, a rubbing material made of a flexible material, is arranged so as to be movable and rotatable around the axis (hereinafter, optionally, referred to as “brush axis”) 3A and such that the brush material can come into contact with the electroconductive substrate 1. As a result, the brush 3 can move relative to the electroconductive substrate 1 while turning around the brush axis 3A as the center. The brush 3 may move in any direction as long as a portion, corresponding to an image-forming area, of the surface of the electroconductive substrate 1 comes into contact with the brush 3, and usually moves in the direction parallel (vertical direction in the drawing) to the axis of the electroconductive substrate 1.

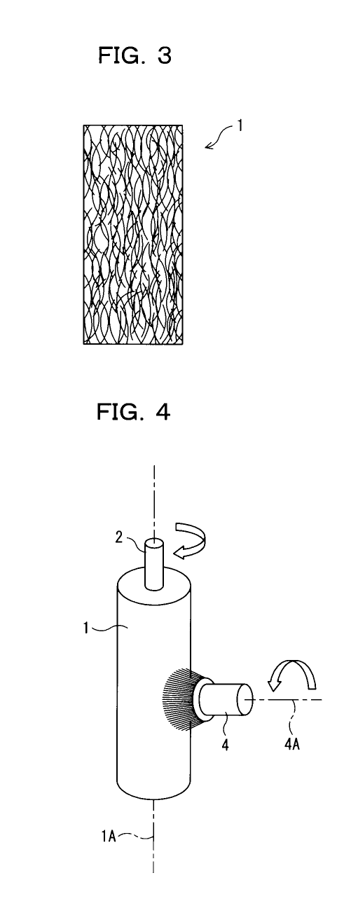

In the case using a wheel-shaped brush 3 such as this example, the positional relation of the rotation axis (usually, axis 3A of the brush) of the brush to the electroconductive substrate 1 is preferably not parallel to each other in order to form arc-shaped grooves (refer to FIGS. 2 and 3). That is, in order to avoid process nonuniformity due to unevenness of contact caused by tilted rotation axes of the electroconductive substrate 1 and the brush 3 or biased wear of the brush, the rotation axis of the brush 3 (i.e., axis 3A of the brush) is preferably set at a position (skew position) which is not the same plane with respect to the substrate axis 1A of the electroconductive substrate 1.

If the substrate axis 1A and the brush axis 3A are parallel to each other, it is difficult to form curved and discontinuous arc-shaped grooves. In such a case, the differences in length and density of the brush material cause unevenness of the grinding power of the brush 3 (in particular, unevenness in the brush axis 3A direction). Since this unevenness is directly transferred to the surface of the electroconductive substrate 1, the state of the ground surface of the electroconductive substrate 1 is also uneven in the axis direction, resulting in occurrence of nonuniformity.

Local process nonuniformity can be improved by a technique of relative vibration of the brush 3 or the electroconductive substrate 1 in the axis direction, as described in Japanese Unexamined Patent Application Publication No. HEI 9-114118. However, even in such a technique, process nonuniformity may occur in the entire axis direction of the electroconductive substrate 1.

In the case that arc-shaped grooves are formed as in this example, the rotating brush 3 is brought into contact with the surface of the electroconductive substrate 1 and is moved in the axis direction of the electroconductive substrate 1. In such a case, the electroconductive substrate 1 is also turned with the substrate axis 1A as the center. In FIG. 1, the rotation directions of the electroconductive substrate 1 and the brush 3 are indicated by arrows.

As a result, the brush 3 is brought into contact with the electroconductive substrate 1 while being elastically deformed, thereby forming arc-shaped grooves on the surface of the electroconductive substrate 1. In particular, in the arrangement such that the substrate axis 1A and the brush axis 3A are approximately perpendicular to each other as shown in FIG. 1, arc-shaped grooves are formed in an oblique direction, as shown in FIG. 2, when the electroconductive substrate 1 is developed, by setting the rotation speed of the brush 3 slow and the contact width small. On the other hand, arc-shaped grooves are formed in a grid pattern, as shown in FIG. 3, by setting the rotation speed of the brush 3 high and the contact width large. In the comparison of the both, a high-speed rotation of the brush 3 and a large contact width increase productivity and are more preferable.

The relative movement of the brush 3 with respect to the electroconductive substrate 1 is usually sufficient when it is conducted once, but may be conducted two or more times. In the case of moving two or more times, the brush may be relatively moved in one direction or may be reciprocally.

The brush in this example is a wheel-shaped brush 3, but is not limited thereto. For example, a cup-shaped brush 4 shown in FIG. 4 may be used. In the case of using the cup-shaped brush 4, the brush axis 4A and the substrate axis 1A may lie in the same plane as long as the axis 4A is not parallel to the axis 1A. In FIG. 4, portions indicated by the same reference numerals as in FIG. 1 represent the same components.

In the case of using a wheel-shaped brush 3 as shown in FIG. 1, the wheel-shaped brush 3 may have any configuration. Accordingly, a brush material may be planted zigzag into an electroconductive substrate 1. However, in order to increase the planting density, a configuration having a channel brush 4 (sic) wrapped around a shaft material is preferable.

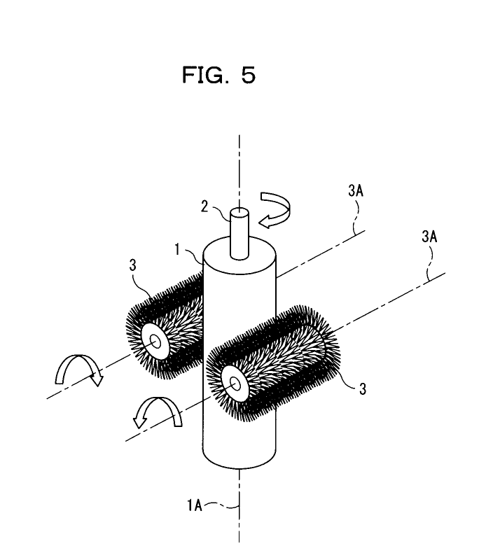

Furthermore, as shown in FIG. 5, a plurality of brushes 3 may be used. The productivity can be enhanced by these brushes 3, and the surface of the electroconductive substrate 1 can have a more complex profile roughened by changing the rotation conditions of each brush 3. Consequently, the effect of suppressing interference fringes can be further improved. In FIG. 5, portions indicated by the same reference numerals as in FIG. 1 represent the same components.

The surface of the electroconductive substrate 1 may have remaining grind powder (for example, powder of ground electroconductive substrate 1). In addition, when the brush 3 contains abrasive grains, the abrasive grains are desorbed from the brush 3 and may remain on the surface of the electroconductive substrate 1. Accordingly, the roughening process is preferably conducted while applying a washing liquid or being immersed in a washing liquid in order to remove microparticles, such as the grind powder and abrasive grains desorbed from the brush 3, from the surface of the electroconductive substrate 1. Any washing liquid can be used, for example, various types of organic and aqueous washing agents can be used. In addition, ammonia added water, which is used for washing semiconductors for preventing adsorption of microparticles, can be used.

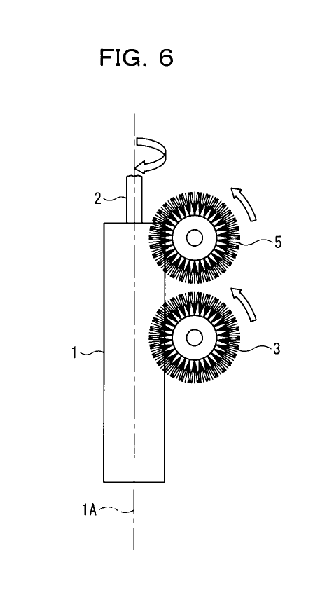

Furthermore, a new face is exposed in the surface of the electroconductive substrate 1 by roughening. If an undercoat layer is not formed immediately after roughening, the surface of the electroconductive substrate 1 can be protected from corrosion by roughening the surface using processed oil instead of the washing liquid. In not only such a case but also other cases, the washing for finishing is preferably conducted after the roughening and before the formation of the undercoat layer. Furthermore, the roughening process is preferably incorporated in the washing process of the electroconductive substrate before the forming of the undercoat layer in order to increase productivity. For example, as shown in FIG. 6, potent physical washing can be conducted immediately after the roughening by arranging a brush 3 for roughening directly below a washing brush 5. Consequently, roughening can be conducted while the surface of the electroconductive substrate 1 is maintained clean. In FIG. 6, portions indicated by the same reference numerals as in FIG. 1 represent the same components.

Here, the brush 3 moves relative to the electroconductive substrate 1 by moving the brush 3, but the electroconductive substrate 1 may be moved. Furthermore, the brush 3 moves relative to the electroconductive substrate 1 by moving both the electroconductive substrate 1 and the wheel-shaped brush 3.

### [I-4. Other Items on Electroconductive Substrate]

In the case of using a metal material such as an aluminum alloy as the electroconductive substrate, the metal material may be used after anodization treatment. If the anodization treatment is performed, it is desirable to conduct pore sealing treatment by a known method.

### [II. Undercoat Layer]

The undercoat layer contains metal oxide particles and a binder resin. In addition, the undercoat layer may contain other components that do not significantly impair the effects of the present invention.

The undercoat layer according to the present invention is provided between the electroconductive substrate and the photosensitive layer and has at least one function selected from the group including an improvement in adhesion between the electroconductive substrate and the photosensitive layer, covering of blot and scratches of the electroconductive substrate, prevention of carrier injection due to impurities or non-uniform surface properties, an improvement in uniformity of electric characteristics, prevention of a decrease in surface potential during repeated use, and prevention of a change in local surface potential, which causes image defects. The undercoat layer is unnecessary for achieving photoelectric characteristics.

### [II-1. Metal Oxide Particles]

### [II-1-1. Type of Metal Oxide Particles]

Any metal oxide particle that can be used in an electrophotographic photoreceptor can be used as the metal oxide particles according to the present invention.

Examples of metal oxides that form the metal oxide particles include metal oxides containing single metal elements, such as titanium oxide, aluminum oxide, silicon oxide, zirconium oxide, zinc oxide, and iron oxide; and metal oxides containing multiple metal elements, such as calcium titanate, strontium titanate, and barium titanate. In particular, metal oxide particles composed of a metal oxide having a band gap of 2 to 4 eV are preferred. When the band gap is too small, carrier injection from the electroconductive substrate easily occurs, resulting in image defects such as black spots and color spots. When the band gap is too large, charge transfer may be precluded by electron trapping, resulting in deterioration of electronic characteristics.

Furthermore, the metal oxide particles may be composed of one type of particles or any combination of different types of particles in any ratio. In addition, the metal oxide particles may be composed of one metal oxide or may be any combination of two or more metal oxides in any ratio.

The metal oxide forming the metal oxide particles is preferably titanium oxide, aluminum oxide, silicon oxide, or zinc oxide, more preferably titanium oxide or aluminum oxide, and most preferably titanium oxide.

Furthermore, the metal oxide particles may have any crystal form that does not significantly impair the effects of the present invention. For example, the crystal form of the metal oxide particles composed of titanium oxide (i.e., titanium oxide particles) is not limited and may be any of rutile, anatase, brookite, or amorphous. In addition, these crystal forms of the titanium oxide particles may be present together.

Furthermore, the metal oxide particles may be subjected to various kinds of surface treatment, for example, treatment with a treating agent such as an inorganic material, e.g., tin oxide, aluminum oxide, antimony oxide, zirconium oxide, or silicon oxide or an organic material, e.g., stearic acid, a polyol, or an organic silicon compound.

In particular, when titanium oxide particles are used as the metal oxide particles, surface treatment is preferably conducted with an organic silicon compound. Examples of the organic silicon compound include silicone oils such as dimethylpolysiloxane and methylhydrogenpolysiloxane; organosilanes such as methyldimethoxysilane and diphenyldimethoxysilane; silazanes such as hexamethyldisilazane; and silane coupling agents such as vinyltrimethoxysilane, γ-mercaptopropyltrimethoxysilane, and γ-aminopropyltriethoxysilane.

Furthermore, the metal oxide particles are preferably treated with a silane treating agent represented by the following Formula (i):

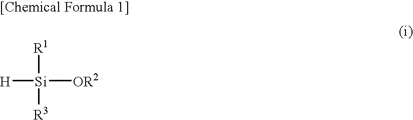

This silane treating agent has high reactivity with metal oxide particles and is a favorable treating agent.

In Formula (i), R¹ and R² each independently represent an alkyl group. The carbon numbers of R¹ and R² are not limited, but are each usually one or more and usually 18 or less, preferably 10 or less, and more preferably 6 or less. Preferable examples of R¹ and R² include a methyl group and an ethyl group.

In addition, in Formula (i), R³ represents an alkyl group or an alkoxy group. The carbon number of R³ is not limited, but is usually one or more and usually 18 or less, preferably 10 or less, and more preferably 6 or less. Preferable examples of R³ include a methyl group, an ethyl group, a methoxy group, and an ethoxy group.

Larger carbon numbers of R¹ to R³ may cause less reactivity with metal oxide particles, or lower dispersion stability of the metal oxide particles, in a coating liquid for forming an undercoat layer, after treatment.

The outermost surfaces of these surface-treated metal oxide particles are usually treated with a treating agent described above. In such a case, the above-described surface treatment may be one type of treatment or may be any combination of two or more types of treatment. For example, before the surface treatment with a silane treating agent represented by Formula (i), treatment with a treating agent, such as aluminum oxide, silicon oxide, or zirconium oxide, may be conducted. Furthermore, any combination of metal oxide particles subjected to different types of surface treatment in any ratio may be employed.

Examples of commercial products of the metal oxide particles according to the present invention are shown below, but the metal oxide particles according to the present invention are not limited to the products shown below.

Commercially available examples of the titanium oxide particles include ultrafine titanium oxide particles without surface treatment, “TTO-55 (N)”; ultrafine titanium oxide particles coated with Al₂O₃, “TTO-55 (A)” and “TTO-55 (B)”; ultrafine titanium oxide particles surface-treated with stearic acid, “TTO-55 (C)”; ultrafine titanium oxide particles surface-treated with Al₂O₃ and organosiloxane, “TTO-55 (S)”; high-purity titanium oxide “CR-EL”; titanium oxide produced by a sulfate process, “R-550”, “R-580”, “R-630”, “R-670”, “R-680”, “R-780”, “A-100”, “A-220”, and “W-10”; titanium oxide produced by a chlorine process, “CR-50”, “CR-58”, “CR-60”, “CR-60-2”, and “CR-67”; and electroconductive titanium oxide, “SN-100P”, “SN-100D”, and “ET-300W” (these are manufactured by Ishihara Industry Co., Ltd.); titanium oxide such as “R-60”, “A-110”, and “A-150”; titanium oxide coated with Al₂0₃, “SR-1”, “R-GL”, “R-5N”, “R-5N-2”, “R-52N”, “RK-1”, and “A-SP”; titanium oxide coated with SiO₂ and Al₂O₃, “R-GX” and “R-7E”; titanium oxide coated with ZnO, SiO₂, and Al₂O₃, “R-650”; titanium oxide coated with ZrO₂ and Al₂O₃, “R-61N” (these are manufactured by Sakai Chemical Industry Co., Ltd.); and titanium oxide surface-treated with SiO₂ and Al₂O₃, “TR-700”; titanium oxide surface-treated with ZnO, SiO₂, and Al₂O₃, “TR-840” and “TA-500”; titanium oxide without surface treatment, “TA-100”, “TA-200”, and “TA-300”; titanium oxide surface-treated with Al₂O₃, “TA-400” (these are manufactured by Fuji Titanium Industry Co., Ltd.); titanium oxide without surface treatment, “MT-150W” and “MT-500B”; titanium oxide surface-treated with SiO₂ and Al₂O₃, “MT-100SA” and “MT-500SA”; and titanium oxide surface-treated with SiO₂, Al₂O₃ and organosiloxane, “MT-100SAS” and “MT-500SAS” (these are manufactured by Tayca Corp.).

Commercially available examples of the aluminum oxide particles include “Aluminium Oxide C” (manufactured by Nippon Aerosil Co., Ltd.).

Commercially available examples of the silicon oxide particles include “200CF” and “R972” (manufactured by Nippon Aerosil Co., Ltd.) and “KEP-30” (manufactured by Nippon Shokubai Co., Ltd.).

Commercially available examples of the tin oxide particles include “SN-100P” (manufactured by Ishihara Industry Co., Ltd.).

Commercially available examples of the zinc oxide particles include “MZ-305S” (manufactured by Tayca Corp.).

### [II-2. Physical Properties of Metal Oxide Particles]

The metal oxide particles according to the present invention satisfy the following requirements for the particle diameter distribution. That is, the metal oxide particles have a volume average particle diameter of 0.1 μm or less and a 90% cumulative particle diameter of 0.3 μm or less which are measured by a dynamic light-scattering method in a liquid of an undercoat layer of the present invention dispersed in a solvent mixture of methanol and 1-propanol at a weight ratio of 7:3 (hereinafter, optionally, referred to as “dispersion for undercoat layer measurement”).

This point will be described in detail below.

### [Regarding Volume Average Particle Diameter of Metal Oxide Particles]

The metal oxide particles according to the present invention have a volume average particle diameter of 0.1 μm or less, preferably 95 nm or less, and more preferably 90 nm or less which is measured by the dynamic light-scattering method in a dispersion for undercoat layer measurement. The volume average particle diameter has no lower limit, but is usually 20 nm or more. The electrophotographic photoreceptor of the present invention, which satisfies the above-mentioned range, is stabilized in repeated exposure-charge characteristics under low temperature and low humidity, and occurrence of image defects such as black spots and color spots can be suppressed.

### [Regarding 90% Cumulative Particle Diameter of Metal Oxide Particles]

The metal oxide particles according to the present invention have a 90% cumulative particle diameter of 0.3 μm or less, preferably 0.25 μm or less, and more preferably 0.2 μm or less which is measured by the dynamic light-scattering method in a dispersion for undercoat layer measurement. In addition, the 90% cumulative particle diameter has no lower limit, but is generally 10 nm or more, preferably 20 nm or more, and more preferably 50 nm or more. In conventional electrophotographic photoreceptors, the undercoat layer contains huge metal oxide particle agglomerates that are formed by agglomeration of the metal oxide particles and extend across the undercoat layer from one surface to the other. Such huge metal oxide particle agglomerates may cause defects in an image formed. Furthermore, in the case using contact-type charging means, charge may migrate from the charged photosensitive layer to an electroconductive substrate through the metal oxide particles, and thereby the charging may not be properly achieved. However, in the electrophotographic photoreceptor of the present invention, since the 90% cumulative particle diameter is significantly small, the number of metal oxide particles having a large size such as to cause defects as described above is significantly reduced. As a result, in the electrophotographic photoreceptor of the present invention, occurrence of defects and improper charging can be prevented, and thereby a high-quality image can be formed.

### [Methods for Measuring Volume Average Particle Diameter and 90% Cumulative Particle Diameter]

The volume average particle diameter and the 90% cumulative particle diameter of the metal oxide particles according to the present invention are values obtained by preparing a dispersion for undercoat layer measurement by dispersing the undercoat layer in a solvent mixture of methanol and 1-propanol at a weight ratio of 7:3 (this functions as a dispersion medium in the measurement of the particle size); and measuring particle size distribution of the metal oxide particles in the dispersion for undercoat layer by a dynamic light-scattering method.

In the dynamic light-scattering method, the particle size distribution is determined by irradiating finely dispersed particles with laser light and detecting the scattering (Doppler shift) of light beams having different phases depending on the velocity of the Brownian motion of these particles. Values of the volume average particle diameter and the 90% cumulative particle diameter of the metal oxide particles in the dispersion for undercoat layer measurement are those when the metal oxide particles are stably dispersed in the dispersion for undercoat layer measurement and do not mean particle diameters in the formed undercoat layer. Specifically, actual measurements of the volume average particle diameter and the 90% cumulative particle diameter are conducted with a dynamic light-scattering particle size analyzer (manufactured by Nikkiso Co., Ltd., MICROTRAC UPA model: 9340-UPA, hereinafter abbreviated to UPA) under the conditions shown below. The actual measurement is conducted according to the instruction manual of the particle size analyzer (Nikkiso Co., Ltd., Document No. T15-490A00, revision No. E).

### Setting of the Dynamic Light-Scattering Particle Size Analyzer

Upper measurement limit: 5.9978 μm

Lower measurement limit: 0.0035 μm

Number of channels: 44

Measurement time: 300 sec

Particle transparency: absorptive

Particle refractive index: N/A (not available)

Particle shape: non-spherical

Density: 4.20 g/cm³ (*)

Dispersion medium: methanol/1-propanol=7/3

Refractive index of dispersion medium: 1.35

(*) This density value is applicable to titanium dioxide particles, and, for other particles, values described in the instruction manual are used.

The amount of a solvent mixture used, as a dispersion medium, of methanol and 1-propanol (weight ratio: methanol/1-propanol=7/3, refractive index=1.35) is adjusted so that the sample concentration index (SIGNAL LEVEL) of the dispersion for undercoat layer measurement ranges from 0.6 to 0.8.

The particle size by dynamic light-scattering is measured at 25° C.

The volume average particle diameter and the 90% cumulative particle diameter of the metal oxide particles according to the present invention are defined as follows: When the particle size distribution is measured by the dynamic light-scattering method described above, and when the cumulative curve of the volume particle size distribution is plotted from the minimum particle size by the dynamic light-scattering method where the total volume of the metal oxide particles is 100%, the particle size at a point of 50% in the cumulative curve is defined as the volume average particle diameter (median diameter), and the particle size at a point of 90% in the cumulative curve is defined as the 90% cumulative particle diameter.

### [Other Physical Properties]

The metal oxide particles according to the present invention may have any average primary particle diameter that does not significantly impair the effects of the present invention. However, the average primary particle diameter of the metal oxide particles according to the present invention is usually 1 nm or more and preferably 5 nm or more and usually 100 nm or less, preferably 70 nm or less, and more preferably 50 nm or less.

Furthermore, this average primary particle diameter can be determined based on the arithmetic mean value of the diameters of particles that are directly observed by a transmission electron microscope (hereinafter, optionally, referred to as “TEM”).

Also, the refractive index of the metal oxide particles according to the present invention does not have any limitation, and those that can be used in electrophotographic photoreceptors can be used. The refractive index of the metal oxide particles according to the present invention is usually 1.3 or more and preferably 1.4 or more and usually 3.0 or less, preferably 2.9 or less, and more preferably 2.8 or less.

In addition, as the refractive index of metal oxide particles, reference values described in various publications can be used. For example, they are shown in the following Table 1 according to Filler Katsuyo Jiten (Filler Utilization Dictionary, edited by Filler Society of Japan, Taiseisha LTD., 1994).

TABLE 1

| | Refractive index |
|---|---|
| Titanium oxide (rutile) | 2.76 |
| Lead titanate | 2.70 |
| Potassium titanate | 2.68 |
| Titanium oxide (anatase) | 2.52 |
| Zirconium oxide | 2.40 |
| Zinc sulfide | 2.37 to 2.43 |
| Zinc oxide | 2.01 to 2.03 |
| Magnesium oxide | 1.64 to 1.74 |
| Barium sulfate (precipitated) | 1.65 |
| Calcium sulfate | 1.57 to 1.61 |
| Aluminum oxide | 1.56 |
| Magnesium hydroxide | 1.54 |
| Calcium carbonate | 1.57 to 1.60 |
| Quartz glass | 1.46 |

The undercoat layer of the present invention can contain the metal oxide particles and the binder resin at any ratio that does not significantly impair the effects of the present invention. However, in the undercoat layer of the present invention, the amount of the metal oxide particles to one part by weight of the binder resin is usually 0.5 part by weight or more, preferably 0.7 part by weight or more, and more preferably 1.0 part by weight or more and usually 8 parts by weight or less, preferably 4 parts by weight or less, more preferably 3.8 parts by weight or less, and particularly preferably 3.5 parts by weight or less. A smaller ratio of the metal oxide particles to the binder resin may cause unsatisfactory electric characteristics of the resulting electrophotographic photoreceptor, in particular, an increase in the residual potential. A larger ratio may increase image defects, such as black spots and color spots, in an image formed with the electrophotographic photoreceptor.

### [II-2. Binder Resin]

The undercoat layer of the present invention can contain any binder resin that does not significantly impair the effects of the present invention. In general, a binder resin that can be used is soluble in a solvent such as an organic solvent, and is insoluble or hardly soluble in and substantially immiscible with a solvent, such as an organic solvent, that is used in a coating liquid for forming a photosensitive layer.

Examples of such a binder resin include phenoxy resins, epoxy resins, and other resins, e.g., polyvinylpyrrolidone, polyvinyl alcohol, casein, polyacrylic acid, celluloses, gelatin, starch, polyurethane, polyimide, and polyamide. These resins may be used alone or in the cured form with a curing agent. Among them, polyamide resins such as alcohol-soluble copolymerized polyamides and modified polyamides exhibit favorable dispersibility and coating characteristics and are preferred.

Examples of the polyamide resin include so-called copolymerized nylons, such as copolymers of 6-nylon, 66-nylon, 610-nylon, 11-nylon, and 12-nylon; and alcohol-soluble nylon resins, such as chemically modified nylons, e.g., N-alkoxymethyl-modified nylon and N-alkoxyethyl-modified nylon. Examples of commercially available products include “CM4000” and “CM8000” (these are manufactured by Toray Industries, Inc.), “F-30K”, “MF-30”, and “EF-30T” (these are manufactured by Nagase Chemtex Corporation).

Among these polyamide resins, particularly preferred is a copolymerized polyamide resin containing a diamine component corresponding to a diamine represented by the following Formula (ii):

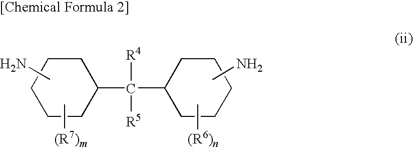

(hereinafter, the diamine component is optionally referred to as “diamine component corresponding to Formula (ii)”).

In Formula (ii), each of R⁴ to R⁷ represents a hydrogen atom or an organic substituent, and m and n each independently represent an integer of from 0 to 4. When a plurality of the substituents are present, these substituents may be the same or different from each other.

Preferable examples of the organic substituent represented by R⁴ to R⁷ include a hydrocarbon group that may contain a hetero atom. Among them, preferred examples are alkyl groups such as a methyl group, an ethyl group, a n-propyl group, and an isopropyl group; alkoxy groups such as a methoxy group, an ethoxy group, a n-propoxy group, and an isopropoxy group; and aryl groups such as a phenyl group, a naphthyl group, an anthryl group, and a pyrenyl group. More preferred are an alkyl group and an alkoxy group; and most preferred are a methyl group and an ethyl group.

The number of the carbon atoms in the organic substituent represented by R⁴ to R⁷ is not limited as long as the effects of the present invention are not significantly impaired, and is usually 20 or less, preferably 18 or less, and more preferably 12 or less and usually 1 or more. When the number of the carbon atoms is too large, the solubility to a solvent for preparing a coating liquid for forming an undercoat layer is decreased. Consequently, the coating liquid for forming an undercoat layer tends to have poor storage stability, even if the resin can be dissolved.

The copolymerized polyamide resin containing a diamine component corresponding to Formula (ii) may contain as a constitutional unit other than the diamine component corresponding to Formula (ii) (hereinafter, optionally, referred to as “other polyamide constituent” simply). Examples of the other polyamide constituent include lactams such as γ-butyrolactam, ε-caprolactam, and lauryllactam; dicarboxylic acids such as 1,4-butanedicarboxylic acid, 1,12-dodecanedicarboxylic acid, and 1,20-eicosanedicarboxylic acid; diamines such as 1,4-butanediamine, 1,6-hexamethylenediamine, 1,8-octamethylenediamine, and 1,12-dodecanediamine; and piperazine. Furthermore, the copolymerized polyamide resin may be, for example, a binary, tertiary, or quaternary copolymer of the constituent.

When the copolymerized polyamide resin containing the diamine component corresponding to Formula (ii) contains another polyamide constitutional unit, the amount of the diamine component corresponding to Formula (ii) to the total constituents is not limited, but is usually 5 mol % or more, preferably 10 mol % or more, and more preferably 15 mol % or more and usually 40 mol % or less and preferably 30 mol % or less. A larger amount of the diamine component corresponding to Formula (ii) may lead to poor stability of the coating liquid for forming an undercoat layer. A smaller amount may cause a significant change in the electric characteristics under conditions of high temperature and high humidity, thereby leading to considerably low stability of the electric characteristics against environmental changes.

Examples of the copolymerized polyamide resin are shown below. In these examples, the copolymerization ratio represents the feed ratio (molar ratio) of monomers.

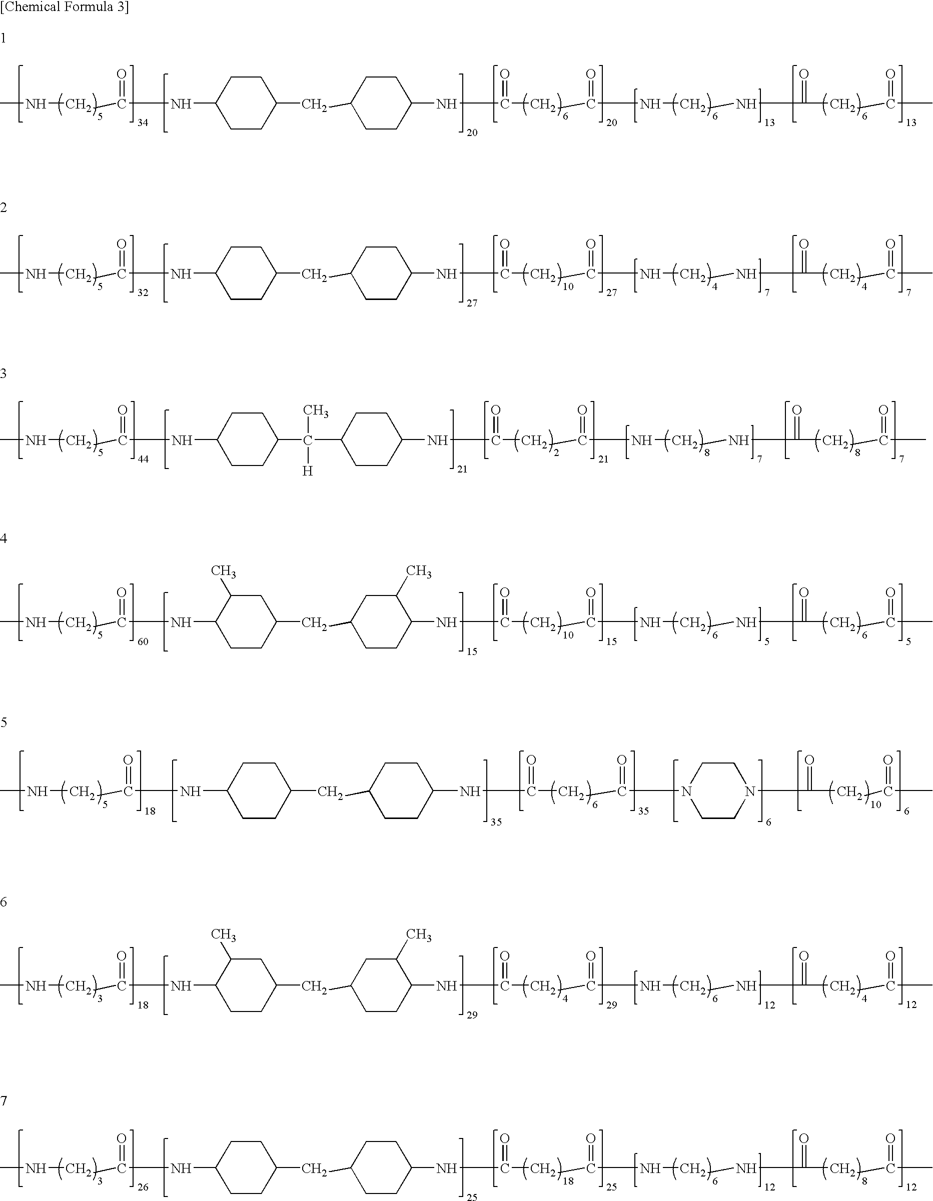

The copolymerized polyamide may be produced by any method without particular limitation and is properly produced by usual polycondensation of polyamide. For example, polycondensation such as melt polymerization, solution polymerization, or interfacial polymerization can be properly employed. Furthermore, in the polymerization, for example, a monobasic acid such as acetic acid or benzoic acid; or a monoacidic base such as hexylamine or aniline may be contained in a polymerization system as a molecular weight adjuster.

The binder resin may be used alone or in any combination of two or more kinds in any ratio.

Furthermore, the binder resin according to the present invention may have any number average molecular weight without limitation. For example, for a binder resin of copolymerized polyamide, the number average molecular weight of the copolymerized polyamide is usually 10000 or more and preferably 15000 or more and usually 50000 or less and preferably 35000 or less. If the number average molecular weight is too small or too large, the undercoat layer tends to be difficult to maintain the uniformity.

### [II-3. Other Component]

The undercoat layer of the present invention may contain other components in addition to the metal oxide particles, the binder resin, and the solvent as long as the effects of the present invention are not significantly impaired. For example, the undercoat layer may contain any additive as the other component.

Examples of the additive include thermal stabilizers represented by sodium phosphite, sodium hypophosphite, phosphorous acid, hypophosphorous acid, and hindered phenol; other polymerization additives; and antioxidants. The additives may be used alone or in any combination of two or more kinds in any ratio.

### [II-4. Physical Properties of Undercoat Layer]

### [Film Thickness]

The undercoat layer may have any thickness. However, from the viewpoints of improvements in photoreceptive characteristics of the electrophotographic photoreceptor of the present invention and in coating characteristics, the thickness is usually 0.1 μm or more, preferably 0.3 μm or more, and more preferably 0.5 μm or more and usually 20 μm or less, preferably 15 μm or less, and more preferably 10 μm or less.

### [Surface Roughness]

The undercoat layer according to the present invention may have any surface profile, but usually has characteristic in-plane root mean square roughness (RMS), in-plane arithmetic mean roughness (Ra), and in-plane maximum roughness (P-V). These numerical values are obtained by applying the reference lengths of the root mean square height, arithmetic mean height, and maximum height in the specification of JIS B 0601:2001 to a reference plane. The in-plane root mean square roughness (RMS) represents the root mean square of Z(x)'s, which are values in the height direction in the reference plane; the in-plane arithmetic mean roughness (Ra) represents the average of the absolute values of Z(x)'s, and the in-plane maximum roughness (P-V) represents the sum of the maximum height and the maximum depth of Z(x).

The in-plane root mean square roughness (RMS) of the undercoat layer according to the present invention is usually 10 nm or more and preferably 20 nm or more and usually 100 nm or less and preferably 50 nm or less. A smaller in-plane root mean square roughness (RMS) may impair the adhesion to an overlying layer. A larger roughness may cause an uneven coating thickness of the overlying layer.

The in-plane arithmetic mean roughness (Ra) of the undercoat layer according to the present invention is usually 10 nm or more and usually 50 nm or less. A smaller in-plane arithmetic mean roughness (Ra) may impair the adhesion to an overlying layer. A larger roughness may cause an uneven coating thickness of the overlying layer.

The in-plane maximum roughness (P-V) of the undercoat layer according to the present invention is usually 100 nm or more and preferably 300 nm or more and usually 1000 nm or less and preferably 800 nm or less. A smaller in-plane maximum roughness (P-V) may impair the adhesion to an overlying layer. A larger roughness may cause an uneven coating thickness of the overlying layer.

The measures (RMS, Ra, P-V) representing the surface profile may be determined with any surface analyzer that can precisely measure irregularities in the reference plane, but, it is preferred to determine these measures by a method of detecting irregularities on the surface of the sample by combining high-precision phase shift detection with counting of the order of interference fringes using an optical interferometer. More specifically, they are preferably measured by an interference fringe addressing method at a wave mode using Micromap manufactured by Ryoka Systems Inc.

### [Absorbance in Dispersion]

When the undercoat layer according to the present invention is dispersed in a solvent that can dissolve the binder resin binding the undercoat layer to prepare a dispersion (hereinafter, optionally, referred to as “dispersion for absorbance measurement”), the absorbance of the dispersion generally has specific physical properties.

The absorbance of the dispersion for absorbance measurement can be measured with a generally known absorption spectrophotometer. Since the conditions for measuring absorbance, such as a cell size and sample concentration, vary depending on physical properties of the metal oxide particles used, such as a particle diameter and a refractive index, in general, the sample concentration is properly adjusted so as not to exceed the detection limit of the detector within the wavelength region (400 to 1000 nm in the present invention) to be measured.

The cell size (light path length) used for the measurement is 10 mm. Any cell can be used as long as the cell is substantially transparent in the range of 400 to 1000 nm. Quartz cells are preferably used, and matched cells having different transmittance characteristics within a predetermined range between a sample cell and a standard cell are particularly preferably used.

Before preparation of a dispersion for absorbance measurement by dispersing the undercoat layer according to the present invention, overlying layers, such as a photosensitive layer, disposed on the undercoat layer are removed by dissolving the layers in a solvent that can dissolve these layers on the undercoat layer, but not substantially dissolve the binder resin binding the undercoat layer, and then the binder resin in the undercoat layer is dissolved in a solvent to give the dispersion for absorbance measurement. The solvent that can dissolve the undercoat layer preferably does not have high light absorption in the wavelength region of 400 to 1000 nm.

Examples of the solvent that can dissolve the undercoat layer include alcohols such as methanol, ethanol, 1-propanol, and 2-propanol. In particular, methanol, ethanol, and 1-propanol are preferred. These solvents may be used alone or in any combination of two or more kinds in any ratio.

In particular, in a dispersion for absorbance measurement dispersing the undercoat layer according to the present invention in a solvent mixture of methanol and 1-propanol at a weight ratio of 7:3, the difference between the absorbance to light with 400 nm wavelength and the absorbance to light with 1000 nm wavelength (absorbance difference) is as follows: For a refractive index of metal oxide particles of 2.0 or more, the absorbance difference is usually 0.3 (Abs) or less and preferably 0.2 (Abs) or less. For a refractive index of metal oxide particles of less than 2.0, the absorbance difference is usually 0.02 (Abs) or less and preferably 0.01 (Abs) or less.

The absorbance depends on the solid content of a liquid to be measured. Therefore, in the measurement of absorbance, the concentration of the metal oxide particles dispersed in the dispersion is preferably adjusted to the range of 0.003 to 0.0075 wt %.

### [Regular Reflection Rate of Undercoat Layer]

The regular reflection rate of the undercoat layer according to the present invention usually shows a value specific to the present invention. The regular reflection rate of the undercoat layer according to the present invention is the rate of the regular reflection of an undercoat layer on an electroconductive substrate to that of the electroconductive substrate. Since the regular reflection rate of the undercoat layer varies depending on the thickness of the undercoat layer, the reflectance here is defined as that when the thickness of the undercoat layer is 2 μm.

In the undercoat layer according to the present invention, for a refractive index of the metal oxide particles contained in the undercoat layer of 2.0 or more, the ratio of the regular reflectance of 480 nm light on the undercoat layer to the regular reflectance of 480 nm light on the electroconductive substrate is usually 50% or more, where the ratio is converted into that of the undercoat layer with a thickness of 2 μm.

On the other hand, for a refractive index of the metal oxide particles contained in the undercoat layer of less than 2.0, the ratio of the regular reflectance of 400 nm light on the undercoat layer to the regular reflectance of 400 nm light on the electroconductive substrate is usually 50% or more, where the ratio is converted into that of the undercoat layer with a thickness of 2 μm.

Here, even if the undercoat layer contains different kinds of metal oxide particles with refractive indices of 2.0 or more or different kinds of metal oxide particles with refractive indices less than 2.0, the regular reflection rate is preferably in the above-mentioned range. Furthermore, even if the undercoat layer contains both metal oxide particles with a refractive index of 2.0 or more and metal oxide particles with a refractive index less than 2.0, as in the case of the undercoat layer containing metal oxide particles with a refractive index of 2.0 or more, the ratio of the regular reflection of 480 nm light on the undercoat layer to the regular reflection of 480 nm light on the electroconductive substrate is preferably in the above-mentioned range (50% or more), where the regular reflection rate is converted into that of the undercoat layer with a thickness of 2 μm.

Hitherto, cases of the undercoat layer having a thickness of 2 μm are described in detail. In the electrophotographic photoreceptor according to the present invention, however, the thickness of the undercoat layer is not limited to 2 μm and may have any thickness. In the case of the undercoat layer having a thickness other than 2 μm, the regular reflection rate can be measured using a coating liquid for forming an undercoat layer (described below) that is used for forming the undercoat layer having a thickness other than 2 μm and forming an undercoat layer having a thickness of 2 μm on an electroconductive substrate equivalent to the electrophotographic photoreceptor and measuring the regular reflection rate of the undercoat layer. Alternatively, the regular reflection rate of the undercoat layer of the electrophotographic photoreceptor is measured, and then the regular reflection rate may be converted into that of an undercoat layer with a thickness of 2 μm.

The conversion process will be described below.

A layer having a small thickness dL and being perpendicular to the light is supposed for the detection of specific monochromatic light that passes through the undercoat layer, is regularly reflected on the electroconductive substrate, and then passes again through the undercoat layer.

A decrease in intensity −dI of the light that passed through the layer with a small thickness dL is proportional to the intensity I before the light passes through the layer and the layer thickness dL, as is expressed by the equation (k is a constant) below.

−dI=kIdL Equation (A).

Equation (A) can be modified as follows:

−dI/I=kdL Equation (B).

By integrating both sides of Equation (B) over the intervals from I₀ to I and from 0 to L, respectively, the following equation is obtained. Here, I₀ represents the intensity of the incident light.

log(I₀/I)=kL Equation (C).

Equation (C) is identical to one called Lambert's law in a solution system and can be applied to measurement of the reflectance in the present invention.

Equation (C) can be modified as follows:

I=I₀ exp(−kL) Equation (D).

The behavior of the incident light before it reaches the surface of an electroconductive substrate is represented by Equation (D).

The reflectance on the surface of a cylinder is represented by R=I₁/I₀ where I₁ represents the intensity of the reflected light, since the denominator of the regular reflection rate is reflected light of the incident light on the conductive substrate.

The light that reaches the surface of the electroconductive substrate in accordance with Equation (D) is reflected after being multiplied by the reflectance R and then passes through the optical path L again toward the surface of the undercoat layer. That is, the following expression is obtained:

I=I₀ exp(−kL) R·exp(−kL) Equation (E).

R=I₁/I₀ is assigned and the equation is further modified to obtain a relationship:

I/I₁=exp(−2kL) Equation (F).

This is the reflectance of the undercoat layer relative to the reflectance of the electroconductive substrate and is defined as the regular reflection rate.

As described above, in the case of a 2 μm undercoat layer, the to-and-fro optical path length is 4 μm, and the reflectance T of the undercoat layer on an optional electroconductive substrate is a function of the thickness L of the undercoat layer (in this case, the optical path length is 2 L) and is represented by T(L). From Equation (F), the following equation is obtained:

T(L)=I/I₁=exp(−2kL) Equation (G).

Furthermore, since the value that should be determined is T(2), L=2 is assigned to Equation (G) to obtain:

T(2)=I/I₁=exp(−4k) Equation (H),

and k is deleted by Equations (G) and (H) to obtain:

T(2)=T(L)^{2/L} Equation (I).

That is, at a thickness L (μm) of the undercoat layer, the reflectance T(2) for an undercoat layer of 2 μm thickness can be estimated with considerable accuracy by measuring the reflectance T(L) of the undercoat layer. The thickness L of the undercoat layer can be measured by any film thickness measuring apparatus such as a roughness meter.

[III. Method for Forming Undercoat Layer]

The undercoat layer according to the present invention can be formed by any method without limitation. However, in general, the undercoat layer can be obtained by applying a coating liquid for forming an undercoat layer containing metal oxide particles and a binder resin onto the surface of an electroconductive substrate and drying the liquid.

### [III-1. Coating Liquid for Forming Undercoat Layer]

The coating liquid for forming an undercoat layer according to the present invention is used for forming the undercoat layer and contains metal oxide particles and a binder resin. In addition, the coating liquid for forming an undercoat layer according to the present invention generally contains a solvent. Furthermore, the coating liquid for forming an undercoat layer according to the present invention may contain other components in amounts that do not significantly impair the effects of the present invention.

### [III-1-1. Metal Oxide Particle]

The metal oxide particles are the same as those described as the metal oxide particles contained in the undercoat layer.

However, the particle diameter distribution of the metal oxide particles in the coating liquid for forming an undercoat layer according to the present invention, in general, should meet the following requirements: The volume average particle diameter and the 90% cumulative particle diameter, measured by a dynamic light-scattering method, of the metal oxide particles in the coating liquid for forming an undercoat layer according to the present invention are the same as the volume average particle diameter and the 90% cumulative particle diameter, measured by a dynamic light-scattering method, respectively, of the metal oxide particles in the dispersion for undercoat layer measurement described above.

Accordingly, in the coating liquid for forming an undercoat layer according to the present invention, the volume average particle diameter of the metal oxide particles is usually 0.1 μm or less (refer to [Regarding volume average particle diameter of metal oxide particles]).

The metal oxide particles in the coating liquid for forming an undercoat layer according to the present invention are desirably present in the form of primary particles. However, in general, it is rare, and, in many cases, the metal oxide particles are aggregated into secondary particles or are present as a mixture of the both. Therefore, the profile of the particle size distribution is significantly important in such a state.

Therefore, in the coating liquid for forming an undercoat layer according to the present invention, precipitation and a change in viscosity in the coating liquid for forming an undercoat layer are suppressed by controlling the volume average particle diameter of the metal oxide particles in the coating liquid for forming an undercoat layer to the aforementioned range (0.1 μm or less), resulting in uniformity of the thickness and the surface characteristics of the formed undercoat layer. On the other hand, a larger volume average particle diameter (larger than 0.1 μm) of the metal oxide particles leads to accelerated precipitation and a large change in viscosity in the coating liquid for forming an undercoat layer, resulting in irregularity of the thickness and the surface characteristics of the formed undercoat layer. This may adversely affect the quality of overlying layers (such as a charge-generating layer).

Furthermore, in the coating liquid for forming an undercoat layer according to the present invention, the metal oxide particles usually have a 90% cumulative particle diameter of 0.3 μm or less (refer to [Regarding 90% cumulative particle diameter of metal oxide particles]).

The metal oxide particles in the coating liquid for forming an undercoat layer according to the present invention are desirably present in the form of primary particles. However, actually, such metal oxide particles cannot be practically obtained. The present inventors have found the fact that when the 90% cumulative particle diameter is sufficiently small, i.e., when the 90% cumulative particle diameter is 0.3 μm or less, the coating liquid for forming an undercoat layer exhibits less gelation and a small change in viscosity and therefore can be stored for a long period of time, even if the metal oxide particles aggregate and that, as a result, the thickness and surface characteristics of the formed undercoat layer can be uniform. On the other hand, when the diameter of the metal oxide particles in the coating liquid for forming an undercoat layer is too large, the gelation and a change in viscosity of the liquid are large and the thickness and surface characteristics of the formed undercoat layer are not uniform. This may also adversely affect the quality of overlying layers (such as a charge-generating layer).

The volume average particle diameter and the 90% cumulative particle diameter of the metal oxide particles in the coating liquid for forming an undercoat layer are directly measured with the coating liquid for forming an undercoat layer, not the metal oxide particles in the dispersion for undercoat layer measurement. This method for measurement is different from that for measuring the volume average particle diameter and the 90% cumulative particle diameter of the metal oxide particles in the dispersion for undercoat layer measurement in the following points (in other points, this method for measuring the volume average particle diameter and the 90% cumulative particle diameter of the metal oxide particles in the coating liquid for forming an undercoat layer is the same as that of the volume average particle diameter and the 90% cumulative particle diameter of the metal oxide particles in the dispersion for undercoat layer measurement).

That is, in the measurement of the volume average particle diameter and the 90% cumulative particle diameter of the metal oxide particles in the coating liquid for forming an undercoat layer, the dispersion medium is the solvent used in the coating liquid for forming an undercoat layer, and the dispersion refractive index is that of the solvent used in the coating liquid for forming an undercoat layer. If the concentration of the coating liquid for forming an undercoat layer is too high and is outside of the range that a measurement apparatus can measure, the coating liquid for forming an undercoat layer is diluted with a solvent mixture of methanol and 1-propanol (weight ratio: methanol/1-propanol=7/3, refractive index=1.35) such that the resulting concentration of the coating liquid for forming an undercoat layer is within the measurable range of the measurement apparatus. For example, in the case of the aforementioned UPA, the coating liquid for forming an undercoat layer is diluted with a solvent mixture of methanol and 1-propanol into a sample concentration index (SIGNAL LEVEL) within the range from 0.6 to 0.8, which is suitable for measurement. Since, even if such dilution is conducted, it is believed that the volume particle diameter of the metal oxide particles in the coating liquid for forming an undercoat layer does not vary, the volume average particle diameter and the 90% cumulative particle diameter after the dilution are regarded as the volume average particle diameter and the 90% cumulative particle diameter of the metal oxide particles in the coating liquid for forming an undercoat layer.

The absorbance of the coating liquid for forming an undercoat layer according to the present invention can be measured with a generally known absorption spectrophotometer. Since the conditions for measuring absorbance, such as a cell size and sample concentration, vary depending on physical properties, such as a particle diameter and a refractive index, of metal oxide particles used, the sample concentration is properly adjusted so as not to exceed the detection limit of a detector in a wavelength region (400 to 1000 nm in the present invention) to be measured. In the present invention, the concentration of the metal oxide particles in the coating liquid for the forming an undercoat layer is controlled to 0.0075 to 0.012 wt %. In general, the solvent for adjusting the sample concentration is the solvent used for the coating liquid for forming an undercoat layer. However, any solvent that has compatibility to the solvent of the coating liquid for forming an undercoat layer and the binder resin and does not cause roiling or the like and does not have high light absorption in a wavelength region of 400 to 1000 nm can be used. Examples of such solvents include alcohols such as methanol, ethanol, 1-propanol, and 2-propanol; hydrocarbons such as toluene and xylene; ethers such as tetrahydrofuran; and ketones such as methyl ethyl ketone and methyl isobutyl ketone.

The cell size (light path length) used for the measurement is 10 mm. Any cell substantially transparent in the range of 400 to 1000 nm can be used. Quartz cells are preferably used, and matched cells having different transmittance characteristics within a predetermined range between a sample cell and a standard cell are particularly preferred.

### [III-1-2. Binder Resin]

The binder resin contained in the coating liquid for forming an undercoat layer is the same as that contained in the undercoat layer, which has been described.

However, the binder resin may be contained in the coating liquid for forming an undercoat layer at any content that does not significantly impair the effects of the present invention, and is usually used in the range of 0.5 wt % or more and preferably 1 wt % or more and usually 20 wt % or less and preferably 10 wt % or less.

### [III-1-3. Solvent]

Any solvent can be used as a solvent for the coating liquid for forming an undercoat layer (solvent for the undercoat layer) according to the present invention as long as it can dissolve the binder resin according to the present invention. The solvent is usually an organic solvent, and examples thereof include alcohols containing at most five carbon atoms, such as methanol, ethanol, isopropyl alcohol, and normal propyl alcohol; halogenated hydrocarbons such as chloroform, 1,2-dichloroethane, dichloromethane, trichlene, carbon tetrachloride, and 1,2-dichloropropane; nitrogen-containing organic solvents such as dimethylformamide; and aromatic hydrocarbons such as toluene and xylene.

These solvents may be used alone or in any combination of two or more kinds in any ratio. Furthermore, even if a solvent cannot dissolve the binder resin according to the present invention by itself, the solvent can be used in the form of a mixture with another solvent (for example, the organic solvents described above) that can dissolve the binder resin. In general, a solvent mixture can advantageously reduce unevenness in coating.

In the coating liquid for forming an undercoat layer according to the present invention, the ratio of solid components, such as the metal oxide particles and the binder resin, to the solvent varies depending on the method for coating the coating liquid for forming an undercoat layer and may be adjusted such that uniform coating can be formed by the coating method that is applied. Specifically, the solid content in the coating liquid for forming an undercoat layer is usually 1 wt % or more and preferably 2 wt % or more and usually 30 wt % or less and preferably 25 wt % or less, from the viewpoints of stability and coating characteristics of the coating liquid for forming an undercoat layer.

### [III-1-4. Other Components]

Other components contained in the coating liquid for forming an undercoat layer are the same as those contained in the undercoat layer, which has been described above.

### [III-1-5. Advantage of Coating Liquid for Forming an Undercoat Layer]

The coating liquid for forming an undercoat layer according to the present invention has high storage stability. There are many measures of storage stability, for example, in the coating liquid for forming an undercoat layer according to the present invention, the rate of change in viscosity after storage for 120 days at room temperature compared to that immediately after the production (i.e., the value obtained by dividing a difference between the viscosity after storage for 120 days and the viscosity immediately after the producing by the viscosity immediately after the producing) is usually 20% or less, preferably 15% or less, and more preferably 10% or less. The viscosity can be measured by a method in accordance with JIS Z 8803 using an E-type viscometer (Tokimec Inc., product name: ED).

Furthermore, the use of the coating liquid for forming an undercoat layer according to the present invention enables highly efficient production of electrophotographic photoreceptors with high quality.

### [III-2. Method of Producing Coating Liquid for Forming the Undercoat Layer]

The coating liquid for forming an undercoat layer according to the present invention may be produced by any method without limitation. However, the coating liquid for forming an undercoat layer according to the present invention contains metal oxide particles as described above, and the metal oxide particles are present in the form of dispersion in the coating liquid for forming an undercoat layer. Therefore, the method of producing the coating liquid for forming an undercoat layer according to the present invention usually includes a step of dispersing the metal oxide particles.

The metal oxide particles may be dispersed in a solvent (hereinafter, optionally, the solvent used for dispersion is referred to as “dispersion solvent”) by wet dispersion using a known mechanical pulverizer (dispersing apparatus), such as a ball mill, a sand grind mill, a planetary mill, or a roll mill. It is believed that the metal oxide particles according to the present invention are dispersed so as to have the above-described predetermined particle diameter distribution through this dispersion step. The dispersion solvent may be that used in the coating liquid for forming an undercoat layer or may be another solvent. However, when a solvent other than the solvent used in the coating liquid for forming an undercoat layer is used as the dispersion solvent, the metal oxide particles after the dispersion and the solvent to be used in the coating liquid for forming an undercoat layer are mixed or subjected to solvent exchange. In such an occasion, it is preferable that the mixing or the solvent exchange be carried out so as to avoid aggregation of the metal oxide particles in order to maintain the predetermined particle diameter distribution.

Among wet dispersion methods, a dispersion using a dispersion medium is preferred.

Any known dispersing apparatus can be used for dispersing using a dispersion medium, and examples thereof include a pebble mill, a ball mill, a sand mill, a screen mill, a gap mill, a vibration mill, a paint shaker, and an attritor. Among them, preferred is a dispersion apparatus that can disperse metal oxide particles by circulation. Furthermore, from the viewpoints of, for example, dispersion efficiency, final particle size, and continuous operation, wet agitating ball mills such as a sand mill, a screen mill, and a gap mill are particularly preferred. These mills may be either of a vertical type or a horizontal type. In addition, the disk of the mill may have any shape, and, for example, a flat plate type, a vertical pin type, or a horizontal pin type can be used. A liquid circulating type sand mill is preferred.

The dispersion may be conducted with one type of dispersion apparatus or with any combination of two or more types.

In the dispersion using a dispersion medium, the volume average particle diameter and the 90% cumulative particle diameter of the metal oxide particles in the coating liquid for forming an undercoat layer can be adjusted within the above-mentioned ranges by using a dispersion medium having a predetermined average particle diameter.

That is, in the method of producing a coating liquid for forming an undercoat layer according to the present invention, metal oxide particles are dispersed in a wet agitating ball mill using a dispersion medium of the wet agitating ball mill having an average particle diameter of usually 5 μm or more and preferably 10 μm or more and usually 200 μm or less and preferably 100 μm or less as the dispersion medium of the wet agitating ball mill. A dispersion medium having a smaller particle diameter tends to give a homogeneous dispersion within a shorter period of time. However, a dispersion medium having an excessively small particle diameter has significantly small mass causing small impact force, which may preclude efficient dispersion.

It is believed that the use of the dispersion medium having the above-described average particle diameter is a factor for adjusting the volume average particle diameter and the 90% cumulative particle diameter of metal oxide particles in a coating liquid for forming an undercoat layer within the desired ranges by the above-mentioned production method. Therefore, the coating liquid for forming an undercoat layer produced in a wet agitating ball mill with metal oxide particles dispersed using a dispersion medium having the above-mentioned average particle diameter favorably satisfies the requirements of the coating liquid for forming an undercoat layer according to the present invention.

Since the dispersion medium is substantially spherical, the average particle diameter can be determined by a sieving method using sieves described in, for example, JIS Z 8801:2000 or image analysis, and the density can be measured by Archimedes's method. Specifically, for example, the average particle diameter and the sphericity of the dispersion medium can be measured with an image analyzer represented by LUZEX50 manufactured by Nireco Corp.

The density of the dispersion medium is not limited, but is usually 5.5 g/cm³ or more, preferably 5.9 g/cm³ or more, and more preferably 6.0 g/cm³ or more. In general, a dispersion medium having a higher density tends to give homogeneous dispersion within a shorter time. The sphericity of the dispersion medium is preferably 1.08 or less and more preferably 1.07 or less.

As the material of the dispersion medium, any known dispersion medium can be used, as long as it is insoluble in a dispersion solvent contained in the aforementioned slurry, and has a specific gravity higher than that of the slurry, and does not react with the slurry nor decompose the slurry. Examples of the dispersion medium include steel balls such as chrome balls (bearing steel balls) and carbon balls (carbon steel balls); stainless steel balls; ceramic balls such as silicon nitride, silicon carbide, zirconium, and alumina balls; and balls coated with films of, for example, titanium nitride or titanium carbonitride. Among them, ceramic balls are preferred, and fired zirconium balls are particularly preferred. More specifically, fired zirconium beads described in Japanese Patent No. 3400836 are particularly preferred.

The dispersion media may be used alone or in any combination of two or more kinds in any ratio.

Among the aforementioned wet agitating ball mills, particularly preferred is one including a cylindrical stator, a slurry supplying port disposed at one end of the stator, a slurry discharging port disposed at the other end of the stator, a rotor for agitating and mixing a dispersion medium packed in the stator and slurry supplied from the supplying port, and a separator that is rotatably connected to the discharging port and separates the dispersion medium and the slurry by the centrifugal force to discharge the slurry from the discharging port.

Here, the slurry contains at least metal oxide particles and a dispersion solvent.

Now, the structure of this wet agitating ball mill will be described in detail.

The stator is a tubular (usually, cylindrical) container having a hollow portion and is provided with a slurry supplying port at one end and a slurry discharging port at the other end. In addition, the hollow portion of the inside is filled with a dispersion medium so that metal oxide particles in slurry are dispersed by the dispersion medium. Furthermore, the slurry is supplied to the inside of the stator from the supplying port, and the slurry in the stator is discharged from the discharging port to the exterior of the stator.

The rotor is disposed in the interior of the stator and promotes mixing of the dispersion medium and the slurry by agitation. The rotor may be any type, such as a pin, disk, or annular type.

Furthermore, the separator separates the dispersion medium and the slurry. This separator is connected to the discharging port of the stator, and separates the slurry and the dispersion medium in the stator, and discharges the slurry from the discharging port of the stator to the exterior of the stator.

The separator used here is rotatable and is desirably of an impeller-type to separate the dispersion medium and the slurry by centrifugal force generated by the rotation of the separator.

The separator may be rotated in synchronization with the rotor or independently of the rotor.

Furthermore, the wet agitating ball mill preferably includes a shaft serving as a rotary shaft of the separator. In addition, this shaft is preferably provided with a hollow discharging path communicating with the discharging port, at the center of the shaft. That is, it is preferable that the wet agitating ball mill include at least a cylindrical stator, a slurry supplying port disposed at one end of the stator, a slurry discharging port disposed at the other end of the stator, a rotor mixing a dispersion medium packed in the stator and slurry supplied from the supplying port, an impeller separator that is connected to the discharging port and is rotatable to separate the dispersion medium and the slurry by centrifugal force and discharge the slurry from the discharging port, and a shaft serving as the rotary shaft of the separator where a hollow discharging path connected to the discharging port is disposed in the center of the shaft.

The above-mentioned discharging path provided to the shaft connects the rotary center of the separator and the discharging port of the stator. Therefore, the slurry separated from the dispersion medium by the separator is transported to the discharging port through the discharging path and is then discharged from the discharging port to the exterior of the stator. The discharging path extends through the center of the shaft. Since the centrifugal force does not work at the center of the shaft, the slurry discharged has no kinetic energy. Thus, since wasteful kinetic energy is not generated, excess energy is not consumed.

Such a wet agitating ball mill may be horizontally disposed, but is preferably vertically disposed in order to increase the filling ratio of the dispersion medium. On this occasion, the discharging port is preferably disposed at the upper end of the mill. Furthermore, the separator is desirably disposed at a position above the level of the packed dispersion medium.

When the discharging port is disposed at the upper end of the mill, the supplying port is disposed at the bottom of the mill. In this case, more preferably, the supplying port consists of a valve seat and a vertically movable valve element that is fitted to the valve seat and has a V-shape, a trapezoidal shape, or a cone shape to be in line contact with the edge of the valve seat. With this, an annular slit can be formed between the edge of the valve seat and the valve element to prevent a dispersion medium from passing through. Therefore, at the supplying port, slurry is supplied without deposition of the dispersion medium. In addition, it is possible to discharge the dispersion medium by spreading the slit by lifting the valve element or to seal the mill by closing the slit by lowering the valve element. Furthermore, since the slit is defined by the valve element and the edge of the valve seat, coarse particles (metal oxide particles) in the slurry barely remain and the remaining slurry readily removes upward or downward. Thus, occlusion hardly occurs.

In addition, coarse particles remaining in the slit can be removed from the slit by vertical vibration of the valve element with vibration means, and occlusion itself of the particles can also be prevented by the vibration. Furthermore, the vibration of the valve element applies shearing force to the slurry to decrease the viscosity thereof, resulting in an increased amount of slurry passing through the slit (i.e., the amount of supply). Any means can be used for vibrating the valve element without limitation. For example, in addition to mechanical means such as a vibrator, means of changing the pressure of compressed air that acts on a piston combined with the valve element, such as a reciprocating compressor or an electromagnetic switching valve of switching supply and discharge of compressed air, can be used.

Such a wet agitating ball mill is desirably provided with a screen for separating the dispersion medium to the bottom and a slurry outlet so that the slurry remaining in the wet agitating ball mill can be discharged after the completion of dispersion.

Furthermore, in the case that the wet agitating ball mill is vertically disposed, the shaft is pivoted at the upper end of the stator, an O-ring and a mechanical seal having a mating ring are disposed at a bearing portion bearing the shaft disposed at the upper end of the stator, and the bearing portion is provided with an annular groove for fitting the O-ring and the O-ring is fitted to the annular groove, it is preferable that a tapered cut broadening downward be provided at the lower side of the annular groove. That is, it is preferable that the wet agitating ball mill include a cylindrical vertical stator, a slurry supplying port disposed at the bottom of the stator, a slurry discharging port disposed at the upper end of the stator, a shaft pivoted at the upper end of the stator and rotated by driving means such as a motor, a pin-, disk-, or annular rotor fixed to the shaft and mixing the dispersion medium packed in the stator and the slurry supplied from the supplying port by agitation, a separator disposed near the discharging port and separating the dispersion medium from the slurry, and a mechanical seal disposed at the bearing portion bearing the shaft at the upper end of the stator, and that a tapered cut broadening downward be provided at the lower side of an annular groove for fitting an O-ring being in contact with a mating ring of the mechanical seal.

In this wet agitating ball mill, the mechanical seal is provided at the upper end of the stator above the level of the liquid in the center of the shaft at which the dispersion medium and the slurry substantially do not have kinetic energy. This can significantly reduce intrusion of the dispersion medium and the slurry into a gap between the mating ring of the mechanical seal and the lower portion of the O-ring fitting groove.

Furthermore, the lower portion of the annular groove for fitting the O-ring broadens downward by a cut so that the clearance spreads. Therefore, intrusion of the slurry and the dispersion medium or clogging caused by solidification thereof hardly occurs, and the mating ring smoothly follows the seal ring to maintain the functions of the mechanical seal. In addition, the lower portion of the fitting groove to which the O-ring is fitted has a V-shaped cross-section, and thereby the entire wall is not thin. Accordingly, the strength is maintained, and the O-ring has high holding ability.

In particular, the separator preferably includes two disks having blade-fitting grooves on the inner faces facing each other, a blade fitted to the fitting grooves and lying between the disks, and supporting means supporting the disks having the blade therebetween from both sides. That is, it is preferable that the wet agitating ball mill include a cylindrical stator, a slurry supplying port disposed at one end of the stator, a slurry discharging port disposed at the other end of the stator, a rotor agitating and mixing the dispersion medium packed in the stator and the slurry supplied from the supplying port, and a rotatable separator provided in the stator, connected to the discharging port, separating the slurry from the dispersion medium by centrifugal force, and discharging the slurry from the discharging port, and that the separator include two disks having fitting grooves for a blade on the inner faces facing each other, the blade fitted to the fitting grooves and lying between the disks, and supporting means supporting the disks having the blade therebetween from both sides. On this occasion, in a preferable embodiment, the supporting means is defined by a shoulder of a shouldered shaft and cylindrical pressing means fitted to the shaft and pressing the disks and supports the disks having the blade therebetween by pinching the disks from both sides with the shoulder of the shaft and the pressing means. With such a wet agitating ball mill, the metal oxide particles in the undercoat layer can readily have a volume average particle diameter and a 90% cumulative particle diameter within the aforementioned ranges. In addition, the separator preferably has an impeller-type structure.

The structure of the above-described vertical wet agitating ball mill will now be more specifically described with reference to an embodiment of the wet agitating ball mill. However, the agitating apparatus used for preparing the coating liquid for an undercoat layer of the present invention is not limited to those exemplified here.

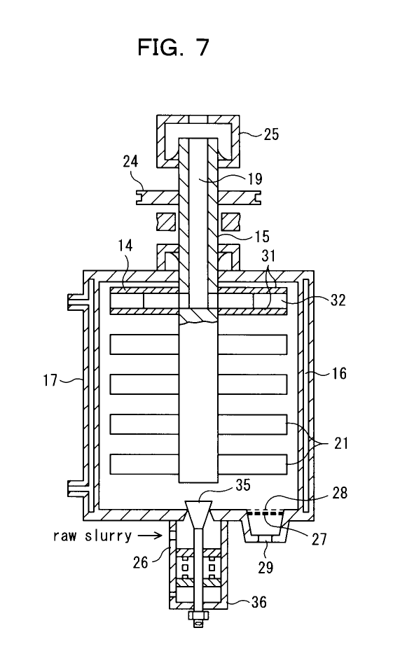

FIG. 7 is a longitudinal cross-sectional view schematically illustrating a structure of a wet agitating ball mill according to this embodiment. In FIG. 7, slurry (not shown) is supplied to the vertical wet agitating ball mill and is agitated with a dispersion medium (not shown) in the mill for pulverization. Then, the slurry is separated from the dispersion medium by a separator 14 and is discharged through a discharging path 19 in the center of a shaft 15 and then is recycled via a return path (not shown) for further milling.

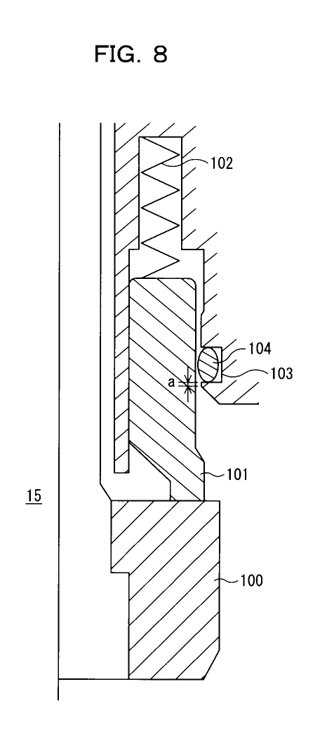

As shown in FIG. 7 in detail, the vertical wet agitating ball mill has a stator 17 provided with a vertically cylindrical jacket 16 that allows a flow of water for cooling the mill; a shaft 15 that is rotatably born on the upper portion of the stator 17 at the center of the stator 17 and has a mechanical seal shown in FIG. 8 (described below) at a bearing portion and has a hollow center as a discharging path 19 at the upper portion; pin- or disk-shaped rotors 21 protruding in the radial direction at the lower portion of the shaft 15; a pulley 24, for transmitting driving force, fixed to the upper portion of the shaft 15; a rotary joint 25 mounted on an open end at the upper end of the shaft 15; a separator 14, for separating the medium, fixed to the shaft 15 near the upper portion in the stator 17; a slurry supplying port 26 disposed to the bottom of the stator 17 so as to oppose to the end of the shaft 15; and a screen 28, for separating the dispersion medium, mounted on a grid screen support 27 that is provided to a slurry retrieval port 29 disposed at an eccentric position of the bottom of the stator 17.

The separator 14 consists of a pair of disks 31 fixed to the shaft 15 with a predetermined interval and a blade 32 connecting these disks 31 to define an impeller and rotates with the shaft 15 to apply centrifugal force to the dispersion medium and the slurry entrapped between the disks 31 for centrifuging the dispersion medium in the radial direction and discharging the slurry through the discharging path 19 in the center of the shaft 15 by the difference in specific gravity.

The slurry supplying port 26 consists of an inverted trapezoidal valve element 35 that is vertically movable and is fitted to a valve seat disposed at the bottom of the stator 17 and a cylindrical body 36 having a bottom and protruding downward from the bottom of the stator 17. The valve element 35 is lifted upon the supply of slurry to form an annular slit (not shown) with the valve seat, whereby the slurry is supplied to the inside of the stator 17.

When a raw material is supplied, the valve element 35 is lifted by a supply pressure due to the slurry supplied to the inside of the cylindrical body 36, against the pressure in the mill, to form a slit between itself and the valve seat.

In order to prevent clogging of the slit, the valve element 35 repeats vertical shock involving lifting to the upper limit position within a short cycle. This vibration of the valve element 35 may be constantly performed, or may be performed when a large amount of coarse particles are contained in the slurry or in conjunction with an increase in supply pressure of the slurry due to clogging.

In the mechanical seal, as shown in FIG. 8 in detail, a mating ring 101 at the stator side is biased by a spring 102 to a seal ring 100 fixed to the shaft 15. The stator 17 and the mating ring 101 are sealed by an O-ring 104 that is fitted to a fitting groove 103 at the stator side. In FIG. 8, a tapered cut (not shown) broadening downward is provided at the lower portion of the O-ring fitting groove 103. The length “a” of minimum clearance between the lower portion of the fitting groove 103 and the mating ring 101 is small in order to prevent deterioration of the sealing between the mating ring 101 and the seal ring 100 due to inhibited motion of the mating ring 101 by solidification of trapped medium or slurry.

In the above embodiment, the rotors 21 and the separator 14 are fixed to the same shaft 15. In another embodiment, however, they are fixed to different shafts coaxially arranged and are independently rotated. In the embodiment shown above, since the rotor and the separator are provided to the same shaft, a single driving apparatus is required, resulting in simplification of the structure. In the latter embodiment, the rotor and the shaft are mounted on the different shafts and are independently rotated by the respective driving apparatuses, and thus the rotor and the separator are independently driven at their optimum rotation rates.

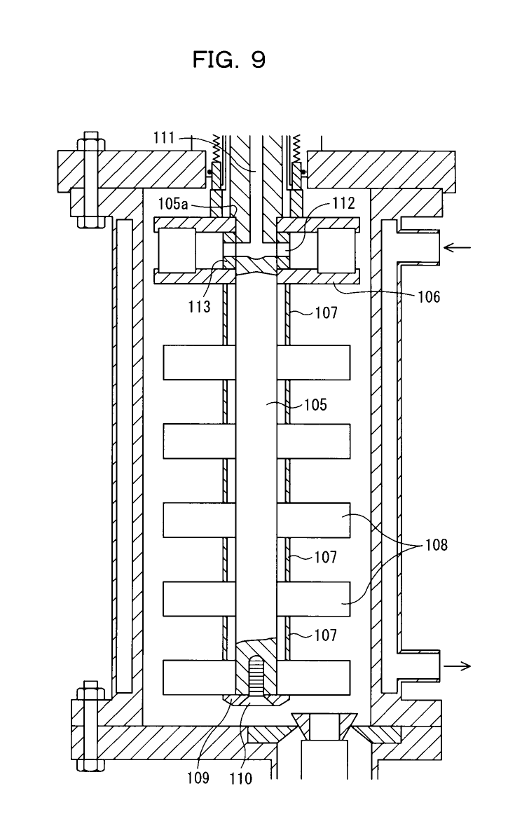

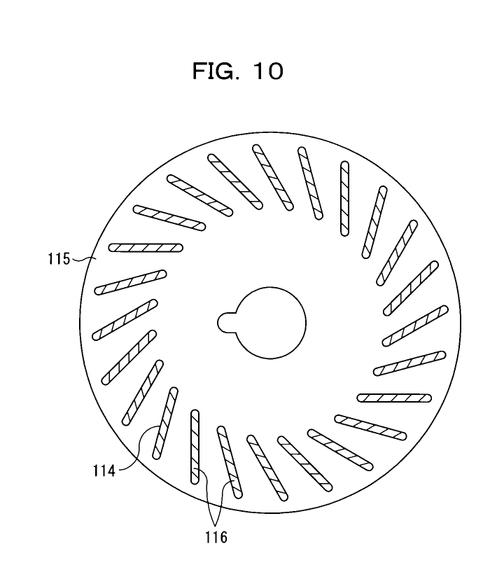

In the ball mill shown in FIG. 9, the shaft 105 is a shouldered shaft. A separator 106 is put on and fitted to the shaft from the lower end of the shaft, then spacers 107 and disk or pin rotors 108 are alternately put on and fitted to the shaft. Then a stopper 109 is fixed to the lower end of the shaft with a screw 110. Thus, the separator 106, the spacers 107, and the rotors 108 are interposed between the shoulder 105a of the shaft 105 and the stopper 109, and fixed in conjunction with each other. The separator 106 includes a pair of disks 115 each provided with blade fitting grooves 114, as shown in FIG. 10, on the inner surfaces facing each other, blades 116 interposing between both the disks and fitted to the blade fitting grooves 114, and an annular spacer 113 for securing a predetermined distance between these disks 115 and having a hole 112 communicating with a discharging path 111 to define an impeller.

An example of the wet agitating ball mill having a structure shown in this embodiment is specifically an Ultra Apex Mill, manufactured by Kotobuki Industries Co., Ltd., for example.

Using the wet agitating ball mill of this embodiment having such a structure, slurry is dispersed through the following procedures: A dispersion medium (not shown) is packed in the stator 17 of the wet agitating ball mill of this embodiment, the rotors 21 and the separator 14 are rotated by driving force from an external power source, while a predetermined amount of slurry is supplied from the supplying port 26. As a result, the slurry is supplied to the interior of the stator 7 through the slit (not shown) formed between the edge of the valve seat and the valve element 35.

The slurry and the dispersion medium in the stator 7 are stirred and mixed by the rotation of the rotors 21 to pulverize the slurry. Furthermore, the dispersion medium and the slurry transferred by the rotation of the separator 14 into the inside of the separator 14 are separated from each other by the difference in specific gravity. The dispersion medium, which has a larger specific gravity, is centrifuged in the radial direction, and the slurry, which has a smaller specific gravity, is discharged through the discharging path 19 in the center of the shaft 15 toward a raw material tank. When the pulverization proceeds to some extent, the particle size of the slurry may be optionally measured. If a desired particle size is obtained, the raw material pump is stopped once, and then mill driving is stopped to terminate the pulverization.

When metal oxide particles are dispersed in a wet agitating ball mill, the filling rate of the dispersion medium packed in the wet agitating mill is not limited, as long as the metal oxide particles can be dispersed into a desired particle size distribution. When metal oxide particles are dispersed in the above-mentioned vertical wet agitating ball mill, the filling rate of the dispersion medium packed in the wet agitating ball mill is usually 50% or more, preferably 70% or more, and more preferably 80% or more and usually 100% or less, preferably 95% or less, and more preferably 90% or less.

The wet agitating ball mill used for dispersing metal oxide particles may have a separator of a screen or slit mechanism, but, as described above, an impeller-type is desirable and a vertical impeller type is preferable. The wet agitating ball mill is desirably of a vertical type having a separator at the upper portion of the mill. In particular, when the filling rate of the dispersion medium is adjusted to the above-mentioned range, pulverization is most efficiently performed, and the separator can be placed at a position higher than the level of the packed medium. This can prevent leakage of a dispersion medium which is carried on the separator.

The operation conditions of the wet agitating ball mill applied to the dispersion of metal oxide particles affect the volume average particle diameter and the 90% cumulative particle diameter of the metal oxide particles in a coating liquid for forming an undercoat layer, the stability of the coating liquid for forming an undercoat layer, the surface profile of the undercoat layer formed by applying the coating liquid for forming an undercoat layer, and characteristics of an electrophotographic photoreceptor having the undercoat layer formed by applying the coating liquid for forming an undercoat layer. In particular, the slurry supplying rate and the rotation velocity of the rotor have significant influences.

The slurry-supplying rate affects the residence time of the slurry in the wet agitating mill because it varies depending on the volume and shape of the mill. In the case of a stator usually used, it is usually 20 kg/hr or more and preferably 30 kg/hr or more and usually 80 kg/hr or less and preferably 70 kg/hr or less per liter (hereinafter, optionally, abbreviated to L) of the wet agitating ball mill capacity.

The rotation velocity of the rotor is affected by parameters such as the shape of the rotor and the distance from the stator. In the case of a stator and a rotor usually used, the circumferential velocity at the top end of the rotor is usually 5 m/sec or more, preferably 8 m/sec or more, and more preferably 10 m/sec or more and usually 20 m/sec or less, preferably 15 m/sec or less, and more preferably 12 m/sec or less.

Furthermore, the amount of the dispersion medium is not limited. However, the volume ratio of the dispersion medium to slurry is usually 1 to 5. In the dispersion, a dispersion aid that can be readily removed after the dispersion may be used together with the dispersion medium. Examples of the dispersion aid include sodium chloride and sodium sulfate.

The dispersion of metal oxide particles is preferably carried out by a wet process in the presence of a dispersion solvent. In addition to the dispersion solvent, any additional component may be present as long as the metal oxide particles can be properly dispersed. Examples of such an additional component include a binder resin and various types of additives.

Any dispersion solvent can be used without limitation, but the solvent that is used in the coating liquid for forming an undercoat layer is preferably used because of no requirement of steps, such as exchange of solvent, after the dispersion. These dispersion solvents may be used alone or as a solvent mixture of two or more kinds in any combination and any ratio.

The amount of the dispersion solvent used is in the range of usually 0.1 part by weight or more and preferably 1 part by weight or more and usually 500 parts by weight or less and preferably 100 parts by weight or less, on the basis of 1 part by weight of metal oxide to be dispersed, from the viewpoint of productivity.

The mechanical dispersion can be carried out at any temperature from the freezing point to the boiling point of a solvent (or solvent mixture), but is usually carried out at a temperature of 10° C. or higher and 200° C. or lower from the viewpoint of safe manufacturing operation.

After the dispersion treatment using a dispersion medium, it is preferable that the dispersion medium be separated and removed from the slurry and further subjected to sonication. The sonication is a treatment of the metal oxide particles with ultrasonic vibration.

Conditions, such as a vibration frequency, for the sonication are not particularly limited, but ultrasonic vibration with a frequency of usually 10 kHz or more and preferably 15 kHz or more and usually 40 kHz or less and preferably 35 kHz or less from an oscillator is used.

Furthermore, the output of an ultrasonic oscillator is not particularly limited, but is usually 100 W to 5 kW.

In general, dispersion treatment of a small amount of slurry with ultrasound from a low output ultrasonic oscillator is more efficient compared to that of a large amount of slurry with ultrasound from a high output ultrasonic oscillator. Therefore, the amount of slurry to be treated at once is usually 1 L or more, preferably 5 L or more, and more preferably 10 L or more and usually 50 L or less, preferably 30 L or less, and more preferably 20 L or less. The output of an ultrasonic oscillator in such a case is preferably 200 W or more, more preferably 300 W or more, and further preferably 500 W or more and preferably 3 kW or less, more preferably 2 kW or less, and further preferably 1.5 kW or less.

The method of applying ultrasonic vibration to metal oxide particles is not particularly limited. For example, the treatment is carried out by directly immersing an ultrasonic oscillator in a container containing slurry, bringing an ultrasonic oscillator into contact with the outer wall of a container containing slurry, or immersing a container containing slurry in a liquid to which vibration is applied with an ultrasonic oscillator. Among these methods, a preferred method is the immersing of a container containing slurry in a liquid to which vibration is applied with an ultrasonic oscillator.

In such a case, the liquid to which vibration is applied with an ultrasonic oscillator is not limited, but examples thereof include water; alcohols such as methanol; aromatic hydrocarbons such as toluene; and oils such as a silicone oil. Among them, water is preferred, in consideration of safe manufacturing operation, cost, washing properties, and other factors.

In the immersion of the container containing slurry in a liquid to which vibration is applied with an ultrasonic oscillator, since the efficiency of the sonication varies depending on the temperature of the liquid, it is preferable to maintain the temperature of the liquid constant. The applied vibration may raise the temperature of the liquid that is subjected to the ultrasonic vibration. The temperature of the liquid subjected to the sonication is in the range of usually 5° C. or higher, preferably 10° C. or higher, and more preferably 15° C. or higher and usually 60° C. or lower, preferably 50° C. or lower, and more preferably 40° C. or lower.

The container for containing the slurry treated with ultrasound is not limited. For example, any container that is usually used for containing a coating liquid for forming an undercoat layer, which is used for forming a photosensitive layer of an electrophotographic photoreceptor, can be also used. Examples of the container include containers made of resins such as polyethylene or polypropylene, glass containers, and metal cans. Among them, metal cans are preferred. In particular, an 18-liter metal can prescribed in JIS Z 1602 is preferred because of its high resistances to organic solvents and impacts.

The slurry after dispersion or after sonication is filtered before use, according to need, in order to remove coarse particles. The filtration medium in such a case may be any filtering material that is usually used for filtration, such as cellulose fiber, resin fiber, or glass fiber. A preferred form of the filtration medium is a so-called wound filter, which is made of a fiber wound around a core material, because it has a large filtration area to achieve high efficiency. Any known core material can be used, and examples thereof include stainless steel core materials and core materials made of resins, such as polypropylene, that are not dissolved in the slurry and not dissolved in the solvent contained in the slurry.

To the resulting slurry, a solvent, a binder resin (binder), and other optional components (e.g., auxiliary agents) are further added to give a coating liquid for forming an undercoat layer. The metal oxide particles may be mixed with the solvent of the coating liquid for forming an undercoat layer, the binder resin, and the other optional components, in any step of before, during, or after the dispersion or sonication process. Therefore, the mixing of the metal oxide particles with the solvent, the binder resin, or the other components may not be necessarily carried out after the dispersion or sonication.

The coating liquid for forming an undercoat layer according to the present invention can be efficiently produced and also can have higher storage stability according to the method of the present invention. Therefore, an electrophotographic photoreceptor with higher quality can be efficiently obtained.

### [111-3. Formation of Undercoat Layer]

The undercoat layer according to the present invention can be formed by applying the coating liquid for forming an undercoat layer according to the present invention onto an electroconductive substrate and drying it. The method of applying the coating liquid for forming an undercoat layer according to the present invention is not limited, and examples thereof include dip coating, spray coating, nozzle coating, spiral coating, ring coating, bar-coat coating, roll-coat coating, and blade coating. These coating methods may be carried out alone or in any combination of two or more.

Examples of the spray coating include air spray, airless spray, electrostatic air spray, electrostatic airless spray, rotary atomizing electrostatic spray, hot spray, and hot airless spray. In consideration of the fineness of grains for obtaining a uniform thickness and adhesion efficiency, a preferred method is rotary atomizing electrostatic spray disclosed in Japanese Domestic Re-publication (Saikohyo) No. HEI 1-805198, that is, continuous conveyance without spacing in the axial direction with rotation of a cylindrical work. This can give an electrophotographic photoreceptor excellent in uniformity of thickness of the undercoat layer at overall high adhesion efficiency.

Examples of the spiral coating method include a method using an injection applicator or a curtain applicator, which is disclosed in Japanese Unexamined Patent Application Publication No. SHO 52-119651; a method of continuously spraying paint in the form of a line from a small opening, which is disclosed in Japanese Unexamined Patent Application Publication No. HEI 1-231966; and a method using a multi-nozzle body, which is disclosed in Japanese Unexamined Patent Application Publication No. HEI 3-193161.

In the case of the dip coating, in general, the total solid content in a coating liquid for forming an undercoat layer is in a range of usually 1 wt % or more and preferably 10 wt % or more and usually 50 wt % or less and preferably 35 wt % or less; and the viscosity is in a range of preferably 0.1 cps or more and preferably 100 cps or less, where 1 cps=1×10⁻³ Pa·s.

After the application, the coating is dried. It is preferable that the drying temperature and time be adjusted so that necessary and sufficient drying is performed. The drying temperature is usually 100° C. or higher, preferably 110° C. or higher, and more preferably 115° C. or higher and usually 250° C. or lower, preferably 170° C. or lower, and more preferably 140° C. or lower. The drying method is not limited. For example, a hot air dryer, a steam dryer, an infrared dryer, or far-infrared dryer can be used.

### [IV. Photosensitive Layer]

The photosensitive layer can have any composition that can be applied to a known electrophotographic photoreceptor, and examples thereof include a so-called single-layer photoreceptor having a single photosensitive layer (single photosensitive layer) containing a binder resin dissolving or dispersing a photoconductive material therein; and a so-called multilayered photoreceptor composed of a plurality of laminated layers (laminated photosensitive layer) including a charge-generating layer containing a charge-generating material and a charge-transporting layer containing a charge-transporting material. It is known that the photoconductive material generally exhibits equivalent functions in both the monolayer and layered photoreceptors.

The photosensitive layer of the electrophotographic photoreceptor of the present invention may be present in any known form, but is preferably a layered photoreceptor, by taking mechanical physical properties, electric characteristics, manufacturing stability, and other characteristics of the photoreceptor into comprehensive consideration. In particular, a normally layered photoreceptor in which an undercoat layer, a charge-generating layer, and a charge-transporting layer are deposited on an electroconductive substrate in this order is more preferable.

### [IV-1. Charge-Generating Material]

The charge-generating material used in an electrophotographic photoreceptor in the present invention may be any material that can be used conventionally in this application. Examples of such materials include azo pigments, phthalocyanine pigments, anthanthrone pigments, quinacridone pigments, cyanine pigments, pyrylium pigments, thiapyrylium pigments, indigo pigments, polycyclic quinone pigments, and squearic acid pigments. In particular, phthalocyanine pigments and azo pigments are preferred. The phthalocyanine pigments can give photoreceptors with high sensitivity to laser light having a relatively long wavelength, and the azo pigments have sufficient sensitivity to white light and laser light having a relatively short wavelength. Thus, both pigments are excellent.

In the present invention, phthalocyanine compounds that can exhibit high performance as charge-generating materials and are therefore preferred. Examples of the phthalocyanine compounds include metal-free phthalocyanine and phthalocyanines with which metals such as copper, indium, gallium, tin, titanium, zinc, vanadium, silicon, and germanium, or oxides thereof, halides thereof, hydroxides thereof, or alkoxides thereof are coordinated.

The phthalocyanine compounds may have any crystal form. In particular, preferred are crystal forms with high-sensitivity, e.g., metal-free phthalocyanines of X-type and τ-type, titanyl phthalocyanine (alias: oxytitanium phthalocyanine) such as A-type (alias: β-type), B-type (alias: α-type), and D-type (alias: Y-type), vanadyl phthalocyanine, chloroindium phthalocyanine, chlorogallium phthalocyanine such as II-type, hydroxygallium phthalocyanine such as V-type, μ-oxo-gallium phthalocyanine dimer such as G-type and I-type, and μ-oxo-aluminum phthalocyanine dimer such as II-type. Among these phthalocyanines, particularly preferred are A-type (β-type), B-type (α-type), and D-type (Y-type) titanyl phthalocyanines, II-type chlorogallium phthalocyanine, V-type hydroxygallium phthalocyanine, and G-type μ-oxo-gallium phthalocyanine dimer.

Furthermore, among these phthalocyanine compounds, preferred are oxytitanium phthalocyanine showing a main diffraction peak at Bragg angle (2θ±0.2°) of 27.3° in the X-ray diffraction spectrum to CuKα characteristic X-rays, oxytitanium phthalocyanine showing main diffraction peaks at 9.3°, 13.2°, 26.2°, and 27.1°, dihydroxysilicon phthalocyanine showing main diffraction peaks at 9.2°, 14.1°, 15.3°, 19.7°, and 27.1°, dichlorotin phthalocyanine showing main diffraction peaks at 8.5°, 12.2°, 13.8°, 16.9°, 22.4°, 28.4°, and 30.1°, hydroxygallium phthalocyanine showing main diffraction peaks at 7.5°, 9.9°, 12.5°, 16.3°, 18.6°, 25.1°, and 28.3°, and chlorogallium phthalocyanine showing diffraction peaks at 7.4°, 16.6°, 25.5°, and 28.3°. Among them, oxytitanium phthalocyanine showing a main diffraction peak at 27.3° is particularly preferable, and, particularly preferably, the oxytitanium phthalocyanine shows main diffraction peaks at 9.5°, 24.1°, and 27.3°.

The charge-generating materials may be used alone or in any combination of two or more kinds in any ratio. Therefore, the above-mentioned phthalocyanine compounds may be used alone or in a mixture of two or more kinds or in a mixed crystal state. Here, the mixture or the mixed crystal state of the phthalocyanine compounds may be obtained by mixing respective constituents afterwards or by causing the mixed state in any production or treatment process of the phthalocyanine compound, such as synthesis, pigment formation, or crystallization. Examples of such treatment are acid-paste treatment, milling treatment, and solvent treatment. To cause a mixed crystal state, for example, as described in Japanese Unexamined Patent Application Publication No. HEI 10-48859, two different crystals are mixed and are then mechanically milled into an amorphous state, and then the mixture is converted into a specific crystal state by solvent treatment.

In addition, in the case of using a phthalocyanine compound, the charge-generating material may be a combination of the phthalocyanine compound with another charge-generating material, such as an azo pigment, a perylene pigment, a quinacridone pigment, a polycyclic quinone pigment, an indigo pigment, a benzimidazole pigment, a pyrylium salt, a thiapyrylium salt, or a squarelium salt.

The charge-generating material is dispersed in a coating liquid for forming a photosensitive layer, and the charge-generating material may be preliminarily pulverized before being dispersed in the coating liquid for forming a photosensitive layer. The pre-pulverization may be carried out with any apparatus, and is usually carried out with, for example, a ball mill or a sand grind mill. The pulverizing medium to be applied to these pulverizers may be any medium that will not be powdered during the pulverization treatment and can be easily separated after the dispersion treatment. Examples of such a medium include beads and balls of glass, alumina, zirconia, stainless steel, or ceramic. In the pre-pulverization, the charge-generating material is pulverized so as to have a volume average particle diameter of preferably 500 μm or less and more preferably 250 μm or less. The volume average particle diameter of the charge-generating material may be measured by any method that is usually used by those skilled in the art, but is usually measured by a sedimentation method or a centrifugal sedimentation method.

### [IV-2. Charge-Transporting Material]

Any charge-transporting material can be used. Examples of the charge-transporting material include polymer compounds such as polyvinyl carbazole, polyvinyl pyrene, polyglycidyl carbazole, and polyacenaphthylene; polycyclic aromatic compounds such as pyrene and anthracene; heterocyclic compounds such as indol derivatives, imidazole derivatives, carbazole derivatives, pyrazole derivatives, pyrazoline derivatives, oxadiazole derivatives, oxazole derivatives, and thiadiazole derivatives; hydrazone-based compounds such as p-diethylaminobenzaldehyde-N,N-diphenylhydrazone and N-methylcarbazole-3-carbaldehyde-N,N-diphenylhydrazone; styryl-based compounds such as 5-(4-(di-p-tolylamino)benzylidene)-5H-dibenzo(a,d)cycloheptene; triarylamine-based compounds such as p-tritolylamine; benzidine-based compounds such as N,N,N′,N′-tetraphenylbenzidine; butadiene-based compounds; and triphenylmethane-based compounds such as di-(p-ditolylaminophenyl)methane. Among them, hydrazone derivatives, carbazole derivatives, styryl-based compounds, butadiene compounds, triarylamine-based compounds, benzidine-based compounds, and products in which some of these compounds are bonded to each other are preferable. These charge-transporting materials may be used alone or in any combination of two or more kinds in any ratio.

### [IV-3. Binder Resin for Photosensitive Layer]

The photosensitive layer according to the electrophotographic photoreceptor of the present invention is formed by binding photoconductive materials with various binder resins. Any known binder resin that can be used in electrophotographic photoreceptor can be used as the binder resin for the photosensitive layer. Examples of the binder resin for the photosensitive layer include polymethylmethacrylate, polystyrene, polyvinyl acetate, polyacrylic acid ester, polymethacrylic acid ester, polyester, polyacrylate, polycarbonate, polyester polycarbonate, polyvinyl acetal, polyvinyl acetoacetal, polyvinyl propional, polyvinyl butyral, polysulfone, polyimide, phenoxy resins, epoxy resins, urethane resins, silicone resins, cellulose ester, cellulose ether, vinyl chloride vinyl acetate copolymers, vinyl polymers such as polyvinyl chloride, and copolymers thereof. In addition, partially cross-linked hardened products thereof can be used. The binder resins for a photosensitive layer may be used alone or in any combination of two or more kinds in any ratio.

### [IV-4. Layer Containing Charge-Generating Material]

### Multilayered Photoreceptor

In the case that the electrophotographic photoreceptor of the present invention is a so-called multilayered photoreceptor, the layer containing a charge-generating material is generally a charge-generating layer. Alternatively, in a multilayered photoreceptor, the charge-generating material may be contained in a charge-transporting layer as long as the effects of the present invention are not significantly impaired.

The volume average particle diameter of the charge-generating material is not limited. In general, the charge-generating material may be dispersed in a coating liquid for forming a photosensitive layer by any method. For example, ball-mill dispersion, attritor dispersion, or sand-mill dispersion is employed. In this process, it is effective for the dispersion to reduce the particle diameter of the charge-generating material in the coating liquid for forming a photosensitive layer to usually 0.5 μm or less, preferably 0.3 μm or less, and more preferably 0.15 μm or less.

The charge-generating layer may have any thickness, but the thickness is usually 0.1 μm or more and preferably 0.15 μm or more and usually 2 μm or less and preferably 0.8 μm or less.

When the layer containing the charge-generating material is a charge-generating layer, the charge-generating material in the charge-generating layer is usually 30 parts by weight or more and preferably 50 parts by weight or more and usually 500 parts by weight or less and preferably 300 parts by weight or less on the basis of 100 parts by weight of the binder resin for the photosensitive layer contained in the charge-generating layer. A smaller amount of the charge-generating material may not impart favorable electric characteristics to the electrophotographic photoreceptor formed, and a larger amount may decrease the stability of the coating liquid.

Furthermore, the charge-generating layer may further contain a known plasticizer for improving film-forming characteristics, flexibility, mechanical strength, or other characteristics, an additive for suppressing a residual potential, a dispersion aid for improving dispersion stability, a leveling agent for improving coating characteristics, a surfactant, a silicone oil, a fluorine-based oil, or another additive. These additives may be used alone or in any combination of two or more kinds in any ratio.

### Single-Layer Photoreceptor

In the case that the electrophotographic photoreceptor of the present invention is a so-called single-layer photoreceptor, the charge-generating material is dispersed in a matrix containing a binder resin for a photosensitive layer and a charge-transporting material as the main components at the same blending ratio as that in a charge-transporting layer described below.

In the case of the single-layer photosensitive layer, it is desirable that the particle diameter of the charge-generating material be sufficiently small. Accordingly, the volume average particle diameter of the charge-generating material in the single-layer photosensitive layer is usually 0.5 μm or less, preferably 0.3 μm or less, and more preferably 0.15 μm or less.

The single-layer photosensitive layer may have any thickness, but the thickness is usually 5 μm or more and preferably 10 μm or more and usually 50 μm or less and preferably 45 μm or less.

The amount of the charge-generating material dispersed in the photosensitive layer is not limited, but a smaller amount may cause insufficient sensitivity, and a larger amount may cause decreases in charging performance and the sensitivity. Accordingly, the content of the charge-generating material in the single-layer photosensitive layer is usually 0.5 wt % or more and preferably 1.0 wt % or more and usually 50 wt % or less and preferably 45 wt % or less.

Furthermore, the photosensitive layer of the single-layer photoreceptor may further contain a known plasticizer for improving film-forming characteristics, flexibility, mechanical strength, or other characteristics, an additive for suppressing a residual potential, a dispersion aid for improving dispersion stability, a leveling agent for improving coating characteristics, a surfactant, a silicone oil, a fluorine-based oil, or another additive. These additives may be used alone or in any combination of two or more kinds in any ratio.

### [IV-5. Layer Containing Charge-Transporting Material]

In the case that the electrophotographic photoreceptor of the present invention is a so-called multilayered photoreceptor, the layer containing a charge-transporting material is generally a charge-transporting layer. The charge-transporting layer may be made of only a resin having a charge-transporting function, but is preferably made of such that the above-mentioned charge-transporting material is dispersed or dissolved in a binder resin for a photosensitive layer.

The charge-transporting layer may have any thickness, but the thickness is usually 5 μm or more, preferably 10 μm or more, and more preferably 15 μm or more and usually 60 μm or less, preferably 45 μm or less, and more preferably 27 μm or less.

In the case that the electrophotographic photoreceptor of the present invention is a so-called single-layer photoreceptor, the single-layer photosensitive layer has a structure in which the charge-transporting material is dispersed or dissolved in a binder resin as a matrix dispersing the charge-transporting layer.

The binder resin used in the layer containing a charge-transporting material may be the binder resin for the photosensitive layer. Among them, examples that can be preferably used in the layer containing a charge-transporting material include polymethylmethacrylate, polystyrene, vinyl polymers such as polyvinyl chloride, and copolymers thereof, polycarbonate, polyarylate, polyester, polyester carbonate, polysulfone, polyimide, phenoxy, epoxy, and silicone resins, and partially cross-linked hardened products thereof. The binder resins may be used alone or in any combination of two or more kinds in any ratio.

In the charge-transporting layer and the single-layer photosensitive layer, the ratio of the binder resin and the charge-transporting material is not limited within the range that does not significantly impair the effects of the present invention. The amount of the charge-transporting material is usually 20 parts by weight or more, preferably 30 parts by weight or more, and more preferably 40 parts by weight or more and usually 200 parts by weight or less, preferably 150 parts by weight or less, and more preferably 120 parts by weight or less, on the basis of 100 parts by weight of the binder resin.

Furthermore, the layer containing the charge-transporting material may optionally contain various additives, for example, an antioxidant such as hindered phenol or hindered amine, an ultraviolet absorber, a sensitizer, a leveling agent, and an electron-attractive material. These additives may be used alone or in any combination of two or more kinds in any ratio.

### [IV-6. Other Layers]

The electrophotographic photoreceptor of the present invention may include any other layer other than the above-mentioned undercoat layer and the photosensitive layer.

For example, a known surface protective layer or an overcoat layer, which is made of thermoplastic or thermosetting polymer as a main component, may be disposed on the outermost layer.

### [IV-7. Formation of Layer]

Each layer other than the undercoat layer having the photoreceptor may be formed by any method. For example, as in the formation of the undercoat layer using the coating liquid for forming an undercoat layer according to the present invention, each coating liquid (for example, a coating liquid for forming a photosensitive layer, a coating liquid for forming a charge-generating layer, or a coating liquid for forming a charge-transporting layer) is prepared by dissolving or dispersing a material to be contained in the layer to be formed in a solvent, and the coating liquid is applied sequentially by a known method, for example, dip coating, spray coating, or ring coating, and drying the liquid. In such a case, the coating liquid may contain various additives, such as a leveling agent, an antioxidant, or a sensitizer, for improving coating properties, according to need.

Any solvent can be used in the coating liquid, but an organic solvent is usually used. Preferable examples of the solvent include alcohols such as methanol, ethanol, propanol, 1-hexanol, and 1,3-butanediol; ketones such as acetone, methyl ethyl ketone, methyl isobutyl ketone, and cyclohexane; ethers such as dioxane, tetrahydrofuran, and ethylene glycol monomethyl ether; ether ketones such as 4-methoxy-4-methyl-2-pentanone; (halo)aromatic hydrocarbons such as benzene, toluene, xylene, and chlorobenzene; esters such as methyl acetate and ethyl acetate; amides such as N,N-dimethylformamide and N,N-dimethylacetamide; and sulfoxides such as dimethyl sulfoxide. Among these solvents, particularly preferred are alcohols, aromatic hydrocarbons, ethers, and ether ketones, and more preferred are toluene, xylene, 1-hexanol, 1,3-butanediol, tetrahydrofuran, and 4-methoxy-4-methyl-2-pentanone.

These solvents may be used alone or in any combination of two or more kinds in any ratio. Examples of solvents that are preferably used in combination include ethers, alcohols, amides, sulfoxides, sulfoxides, (sic) and ether ketones. Among them, preferred are ethers such as 1,2-dimethoxyethane and alcohols such as 1-propanol. Particularly preferred are ethers, from the viewpoints of crystal form stability and dispersion stability of oxytitanium phthalocyanine which is used as the charge-generating material for preparing a coating liquid.

The amount of the solvent used in a coating liquid is not limited, and is properly determined according to the composition of the coating liquid and the method for coating.

### [V. Advantages of Electrophotographic Photoreceptor of the Present Invention]

The electrophotographic photoreceptor of the present invention can form a satisfactory image without image defects such as black spots, color spots, and black lines while preventing fringes by interference of exposure light. In addition, the electrophotographic photoreceptor may have the following advantages.

That is, the electrophotographic photoreceptor of the present invention can form a high-quality image under various operation environments. In addition, this photoreceptor exhibits excellent duration stability. Accordingly, the electrophotographic photoreceptor of the present invention can form an image with high quality with suppressed environmental influence.

In conventional electrophotographic photoreceptors, the undercoat layer contains huge metal oxide particles that are formed by agglomeration of the metal oxide particles, and such huge metal oxide particles may cause defects in an image formed. Furthermore, in the case using contact-type charging means, charge may migrate from the charged photosensitive layer to the electroconductive substrate through the metal oxide particles, and thereby the charging cannot be properly achieved. However, since the electrophotographic photoreceptor of the present invention has an undercoat layer containing metal oxide particles having a very small average particle diameter and a favorable particle diameter distribution, occurrence of the above-mentioned defects and improper charging can be prevented, and thereby a high-quality image can be formed.

### [VI. Image-Forming Apparatus]

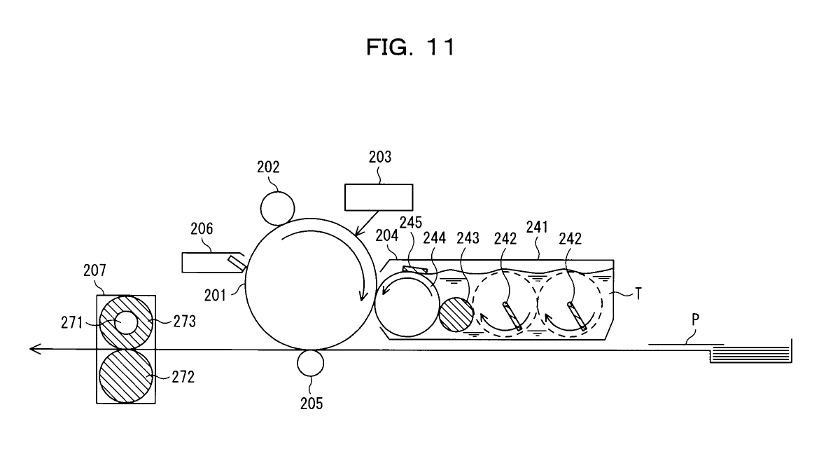

Regarding an embodiment of an image-forming apparatus (image-forming apparatus of the present invention) using the electrophotographic photoreceptor of the present invention, the main structure of the apparatus will now be described with reference to FIG. 11. However, the embodiment is not limited to the following description, and many modifications can be conducted within the scope of the present invention.

As shown in FIG. 11, the image-forming apparatus includes an electrophotographic photoreceptor 201, a charging device (charging means) 202, an exposure device (exposure means; image exposure means) 203, a development device (development means) 204, and a transfer device (transfer means) 205. Furthermore, the image-forming apparatus optionally includes a cleaning device (cleaning means) 206 and a fixation device (fixation means) 207.

The photoreceptor 201 of the image-forming apparatus of the present invention is the above-described electrophotographic photoreceptor of the present invention. That is, in the image-forming apparatus of the present invention including an electrophotographic photoreceptor, charging means for charging the electrophotographic photoreceptor, image exposure means for forming an electrostatic latent image by subjecting the charged electrophotographic photoreceptor to image exposure, development means for developing the electrostatic latent image with toner, and transfer means for transferring the toner to a transfer object, the electrophotographic photoreceptor includes an undercoat layer containing metal oxide particles and a binder resin on an electroconductive substrate having a maximum height surface roughness Rz in the range of 0.8≦Rz≦2 μm, and a photosensitive layer disposed on the undercoat layer, wherein the metal oxide particles have a volume average particle diameter of 0.1 μm or less and a 90% cumulative particle diameter of 0.3 μm or less which are measured by a dynamic light-scattering method in a liquid containing the undercoat layer dispersed in a solvent mixture of methanol and 1-propanol at a weight ratio of 7:3.

The electrophotographic photoreceptor 201 is the above-described electrophotographic photoreceptor of the present invention without any additional requirement. FIG. 11 shows, as such an example, a drum photoreceptor having the above-described photosensitive layer on the surface of a cylindrical electroconductive substrate. Along the outer surface of this electrophotographic photoreceptor 201, a charging device 202, an exposure device 203, a development device 204, a transfer device 205, and a cleaning device 206 are arranged.

The charging device 202 charges the electrophotographic photoreceptor 201 so that the surface of the electrophotographic photoreceptor 201 is uniformly charged to a predetermined potential. It is preferable that the charging device be in contact with the electrophotographic photoreceptor 201 in order to efficiently utilize the effects of the present invention. FIG. 11 shows a roller charging device (charging roller) as an example of the charging device 202, but other charging devices, for example, corona charging devices such as corotron or scorotron and contacting charging devices such as a charging brush, can be suitably used.

In many cases, the electrophotographic photoreceptor 201 and the charging device 202 are integrated into a cartridge (hereinafter, optionally, referred to as “photoreceptor cartridge”) that is detachable from the body of an image-forming apparatus. Such a design makes it possible, for example, to detach the used photoreceptor cartridge from the image-forming apparatus body and attaching a new one to the image-forming apparatus body, when the electrophotographic photoreceptor 201 and the charging device 202 are degraded by the use. In addition, in many cases, toner described below is also stored in a toner cartridge detachable from an image-forming apparatus body. When the toner in the toner cartridge is exhausted in use, the toner cartridge can be detached from the image-forming apparatus body, and a new toner cartridge can be attached to the apparatus body. Furthermore, a cartridge including all the electrophotographic photoreceptor 201, the charging device 202, and the toner may be used.

The exposure device 203 may be any type that can form an electrostatic latent image on a photosensitive surface of the electrophotographic photoreceptor 201 by exposure (image exposure) to the electrophotographic photoreceptor 201, and examples thereof include halogen lamps, fluorescent lamps, lasers such as a semiconductor laser and a He—Ne laser, and LEDs (light-emitting diodes). Furthermore, the exposure may be conducted by a photoreceptor internal exposure system. Any light can be used for the exposure. For example, the exposure may be carried out with monochromatic light having a wavelength of 780 nm; monochromatic light having a slightly shorter wavelength of 600 to 700 nm; or monochromatic light having a shorter wavelength of 350 to 600 nm. Among them, the exposure is preferably carried out with monochromatic light having a short wavelength of 350 to 600 nm and more preferably monochromatic light having a wavelength of 380 to 500 nm.

The development device 204 develops the electrostatic latent image. The development device 204 may be any type, and examples thereof include dry development systems such as cascade development, one-component conductive toner development, and two-component magnetic brush development; and wet development systems. The development device 204 shown in FIG. 11 includes a development tank 241, agitators 242, a supply roller 243, a development roller 244, a control member 245, and the development tank 241 containing toner T therein. In addition, the development device 204 may be provided with an optional refill device (not shown) for refilling the toner T. This refill device can refill the development tank 241 with toner T from a container such as a bottle or a cartridge.

The supply roller 243 is made of, for example, electroconductive sponge. The development roller 244 is, for example, a metal roller made of, e.g., iron, stainless steel, aluminum, or nickel or a resin roller made of such a metal roller coated with, e.g., a silicone resin, a urethane resin, or a fluorine resin. The surface of this development roller 244 may be optionally smoothed or roughened.

The development roller 244 is arranged between the electrophotographic photoreceptor 201 and the supply roller 243 and abuts on both the electrophotographic photoreceptor 201 and the supply roller 243. The supply roller 243 and the development roller 244 are rotated by a rotary drive mechanism (not shown). The supply roller 243 carries the toner T stored and supplies it to the development roller 244. The development roller 244 carries the toner T supplied from the supply roller 243 and brings it into contact with the surface of the electrophotographic photoreceptor 201.

The control member 245 is made of, for example, a resin blade of, e.g., a silicone resin or a urethane resin; a metal blade of, e.g., stainless steel, aluminum, copper, brass, or phosphor bronze; or a blade made of such a metal blade coated with a resin. The control member 245 abuts on the development roller 244 and is biased toward the development roller 244 at a predetermined force (a usual blade line pressure is 5 to 500 g/cm) by, for example, a spring. The control member 245 may have an optional function charging the toner T by frictional electrification.

The agitators 242 are each rotated by a rotary drive mechanism and agitate and transfer the toner T to the supply roller 243. The shapes and sizes of the blade of the agitators 242 may be different from each other.

The toner may be of any type, and polymerized toner prepared by suspension polymerization or emulsion polymerization, as well as powder toner, can be used. In the use of the polymerized toner, a small particle diameter of about 4 to 8 μm is particularly preferred, and various shapes of toner may be used from a spherical shape to a non-spherical shape such as a potato-like shape. Among various toners, the polymerized toner exhibits superior charging uniformity and transferring characteristics and can be suitably used for forming an image with higher quality.

The transfer device 205 may be of any type, and devices employing, for example, electrostatic transfer such as corona transfer, roller transfer, or belt transfer; pressure transfer; or adhesive transfer can be used. The transfer device 205 includes a transfer charger, a transfer roller, and a transfer belt that are arranged so as to face the electrophotographic photoreceptor 201. The transfer device 205 transfers a toner image formed in the electrophotographic photoreceptor 201 to a transfer material (transfer object, paper, medium) P by a predetermined voltage (transfer voltage) with a polarity opposite to that of the charged potential of the toner T. In the present invention, it is effective that the transfer device 205 be in contact with the photoreceptor via the transfer material.

The cleaning device 206 may be of any type, and examples thereof include a brush cleaner, a magnetic brush cleaner, an electrostatic brush cleaner, a magnetic roller cleaner, and a blade cleaner. The cleaning device 206 collects remaining toner adhering to the photoreceptor 201 by scraping the remaining toner with a cleaning member. The cleaning device 206 is unnecessary when the amount of toner remaining on the surface of the photoreceptor is small or substantially zero.

The fixation device 207 is composed of an upper fixation member (fixation roller) 271 and a lower fixation member (fixation roller) 272, and the fixation member 271 or 272 is provided with a heating device 273 therein. FIG. 11 shows an example of the heating device 273 provided inside the upper fixation member 271. The upper and lower fixation members 271 and 272 may be known thermal fixation members, for example, a fixation roller in which a pipe of a metal material, such as stainless steel or aluminum, is coated with a silicone rubber, a fixation roller having a fluorine resin coating, or a fixation sheet. The fixation members 271 and 272 may have a structure for supplying a mold-releasing agent, such as a silicone oil, for improving mold release properties or may have a structure for applying a pressure to each other with, for example, a spring.

The toner transferred onto a recording paper P is heated to be melted when the recording paper P passes through between the upper fixation member 271 and the lower fixation member 272 that are heated to a predetermined temperature, and then is fixed on the recording paper P by cooling thereafter.

The fixation device may be of any type, and examples thereof include, in addition to that described here, devices employing a system of heat roller fixation, flash fixation, oven fixation, or pressure fixation.

In the electrophotographic apparatus having a structure described above, an image is recorded as follows: The surface (photosensitive surface) of the photoreceptor 201 is charged to a predetermined potential (for example, −600 V) with the charging device 202. The charging may be conducted by a direct-current voltage or by a direct-current voltage superimposed by an alternating-current voltage.

Subsequently, the charged photosensitive surface of the photoreceptor 201 is exposed with the exposure device 203 depending on the image to be recorded. Thereby, an electrostatic latent image is formed in the photosensitive surface. This electrostatic latent image formed in the photosensitive surface of the photoreceptor 201 is developed by the development device 204.

In the development device 204, the toner T supplied by the supply roller 243 is spread into a thin layer with the control member (developing blade) 245 and, simultaneously, is charged by friction so as to have a predetermined polarity (here, the toner is charged into negative polarity, which is the same as the polarity of the charge potential of the photoreceptor 201). This toner T is held on the development roller 244 and is conveyed and brought into contact with the surface of the photoreceptor 201.

The charged toner T held on the development roller 244 comes into contact with the surface of the photoreceptor 201, so that a toner image corresponding to the electrostatic latent image is formed on the photosensitive surface of the photoreceptor 201. This toner image is transferred to a recording paper P with the transfer device 205. Thereafter, the toner remaining on the photosensitive surface of the photoreceptor 201 without being transferred is removed with the cleaning device 206.

After the transfer of the toner image to the recording paper P, the recording paper P passes through the fixation device 207 to thermally fix the toner image on the recording paper P. Thereby, an image is recorded.

The image-forming apparatus may have a structure that can conduct, for example, a charge elimination step, in addition to the above-described structure. The charge elimination step neutralizes the electrophotographic photoreceptor by exposing the electrophotographic photoreceptor with light. Examples of such a device for the charge elimination include fluorescent lamps and LEDs. In many cases, the intensity of the light used in the charge elimination step has an exposure energy at least 3 times that of the exposure light.

The structure of the image-forming apparatus may be further modified. For example, the image-forming apparatus may have a mechanism that conducts steps such as a pre-exposure step and a supplementary charging step, that performs offset printing, or that includes a full-color tandem system using different toners.

In the case that a combination of the photoreceptor 201 and the charging device 202 integrated into a cartridge, it is preferable that the cartridge further include the development device 204. Furthermore, a combination of the photoreceptor 201 and, according to need, one or more of the charging device 202, the exposure device 203, the development device 204, the transfer device 205, the cleaning device 206, and the fixation device 207 may be integrated into an integral cartridge (electrophotographic cartridge) that is detachable from an electrophotographic apparatus such as a copier or a laser beam printer. That is, the electrophotographic cartridge of the present invention includes the electrophotographic photoreceptor and at least one of the charging means for charging the electrophotographic photoreceptor, the image exposure means for forming an electrostatic latent image by conducting image exposure to the charged electrophotographic photoreceptor, the development means for developing the electrostatic latent image with toner, the transfer means for transferring the toner to a transfer object, the fixation means for fixing the toner transferred on the transfer object, and the cleaning means for collecting the toner adhering to the electrophotographic photoreceptor, wherein the electrophotographic photoreceptor includes an undercoat layer containing metal oxide particles and a binder resin on an electroconductive substrate having a maximum height surface roughness Rz in the range of 0.8≦Rz≦2 μm, and a photosensitive layer disposed on the undercoat layer, and wherein the metal oxide particles have a volume average particle diameter of 0.1 μm or less and a 90% cumulative particle diameter of 0.3 μm or less which are measured by a dynamic light-scattering method in a liquid containing the undercoat layer dispersed in a solvent mixture of methanol and 1-propanol at a weight ratio of 7:3.

In this case, as in the cartridge described in the above embodiment, for example, even if the electrophotographic photoreceptor 101 (sic) or another member is deteriorated, the maintenance of an image-forming apparatus can be readily performed by detaching this electrophotographic cartridge from the image-forming apparatus body and attaching a new electrophotographic cartridge to the image-forming apparatus body.

The image-forming apparatus and the electrophotographic cartridge of the present invention can form a high-quality image. In particular, a conventional case that a transfer device 5 is in contact with a photoreceptor via a transfer material often results in poor image quality. However, the image-forming apparatus and the electrophotographic cartridge of the present invention hardly cause such low quality and are hence effective.

### Examples

The present invention will now be described in further detail with reference to Examples and Comparative Examples, but is not limited thereto within the scope of the present invention. In the description of Examples, the term “part(s)” means “part(s) by weight” unless otherwise specified.

### Example 1

### [Substrate 1]

A substrate 1 made of an aluminum alloy A6063 defined in JIS H4040 and having an outer diameter of 30 mm, a length of 357 mm, and a thickness of 1.0 mm was prepared by cutting with a polycrystalline diamond bit such that the maximum height surface roughness Rz was 1.3 μm. Part of the substrate 1 was used for measurement of the in-plane arithmetic mean roughness Ra, the maximum height surface roughness Rz, and the kurtosis Rku of the substrate 1. Specifically, these values were measured according to JIS B0601:1994 with a surface roughness measuring instrument “Surfcom 480A”, manufactured by Tokyo Seimitsu Co., Ltd., and the obtained values were applied to the specification of JIS B0601:2001. The results are shown in Table 3.

### [Coating Liquid for Undercoat Layer]

Surface-treated titanium oxide was prepared by mixing rutile titanium oxide having an average primary particle diameter of 40 nm (“TTO55N”, manufactured by Ishihara Sangyo Co., Ltd.) and methyldimethoxysilane (“TSL8117”, manufactured by Toshiba Silicone Co., Ltd.) in an amount of 3 wt % on the basis of the amount of the titanium oxide with a Henschel mixer. 1 kg of raw material slurry composed of a mixture of 50 parts of the surface-treated titanium oxide and 120 parts of methanol was subjected to dispersion treatment for 1 hour using zirconia beads with a diameter of about 100 μm (YTZ, manufactured by Nikkato Corp.) as a dispersion medium and an Ultra Apex Mill (model UAM-015, manufactured by Kotobuki Industries Co., Ltd.) having a mill capacity of about 0.15 L under liquid circulation conditions of a rotor peripheral velocity of 10 m/sec and a liquid flow rate of 10 kg/h to give a titanium oxide dispersion.

The titanium oxide dispersion, a solvent mixture of methanol/1-propanol/toluene, and a pelletized polyamide copolymer composed of ε-caprolactam [compound represented by the following Formula (A)]/bis(4-amino-3-methylcyclohexyl)methane [compound represented by the following Formula (B)]/hexamethylene diamine [compound represented by the following Formula (C)]/decamethylenedicarboxylic acid [compound represented by the following Formula (D)]/octadecamethylenedicarboxylic acid [compound represented by the following Formula (E)] at a molar ratio of 60%/15%/5%/15%/5% were mixed with agitation under heat to dissolve the pelletized polyamide. The resulting solution was subjected to ultrasonic dispersion treatment for 1 hour with an ultrasonic oscillator at an output of 1200 W and then filtered through a PTFE membrane filter with a pore size of 5 μm (Mitex LC, manufactured by Advantech Co., Ltd.) to give a coating liquid A for forming an undercoat layer wherein the weight ratio of the surface-treated titanium oxide/copolymerized polyamide was 3/1, the weight ratio of methanol/1-propanol/toluene in the solvent mixture was 7/1/2, and the solid content was 18.0 wt %.

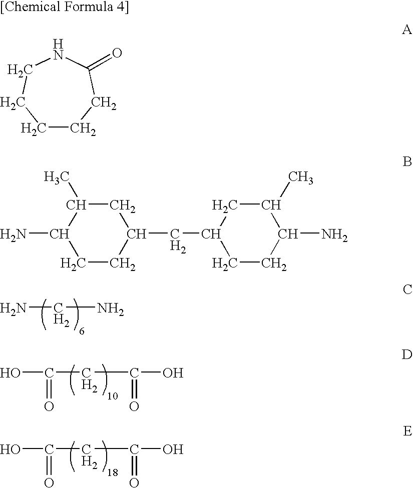

The particle size distribution (the volume average particle diameter and the 90% cumulative particle diameter) of this coating liquid A for forming an undercoat layer was measured with the above-mentioned UPA. The results are shown in Table 2.

This coating liquid A for forming an undercoat layer was applied onto the substrate 1 by dipping to form an undercoat layer with a dried thickness of 1.5 μm. The observation of the surface of the undercoat layer with a scanning electron microscope confirmed substantially no agglomeration on the surface.

### [Coating Liquid for Charge-Generating Layer]

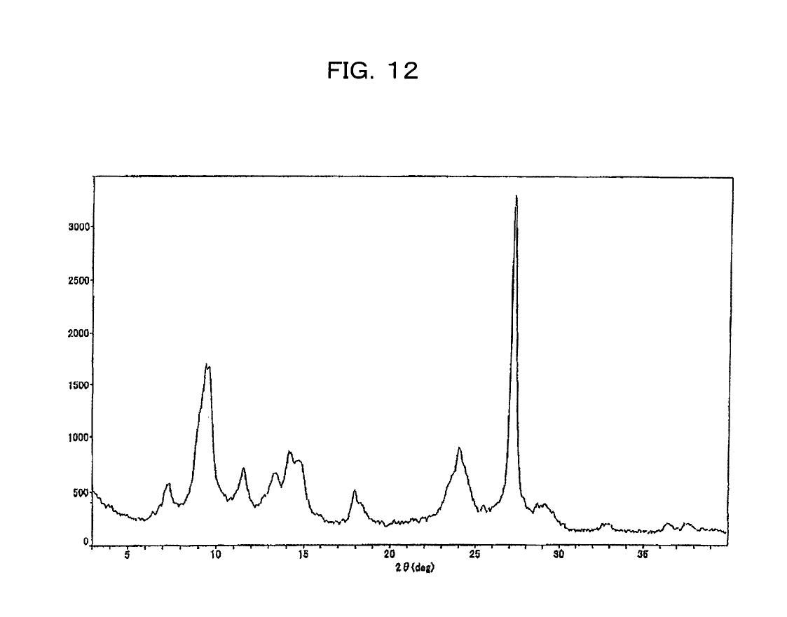

As a charge-generating material, 20 parts by weight of oxytitanium phthalocyanine having a powder X-ray diffraction spectrum pattern to CuKα characteristic X-rays, shown in FIG. 12, and 280 parts by weight of 1,2-dimethoxyethane were mixed and subjected to dispersion treatment in a sand grind mill for 2 hours to give a dispersion. Then, this dispersion was mixed with 10 parts by weight of polyvinyl butyral (trade name “Denka Butyral” #6000C, manufactured by Denki Kagaku Kogyo K. K.), 253 parts by weight of 1,2-dimethoxyethane, and 85 parts by weight of 4-methoxy-4-methylpentanone-2, and then further 234 parts by weight of 1,2-dimethoxyethane was mixed therewith. The resulting mixture was subjected to ultrasonic dispersion treatment and then filtered through a PTFE membrane filter with a pore size of 5 μm (Mitex LC, manufactured by Advantech Co., Ltd.) to prepare a coating liquid 1 for a charge-generating layer. This coating liquid 1 for a charge-generating layer was applied onto the undercoat layer by dipping to form a charge-generating layer with a dried thickness of 0.4 μm.

### [Coating Liquid for Charge-Transporting Layer]

Then, 56 parts of a hydrazone compound represented by the following formula:

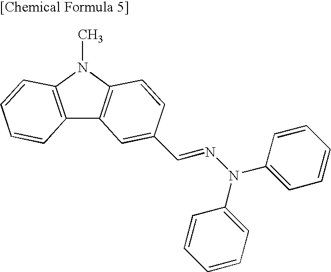

14 parts of a hydrazone compound represented by the following formula:

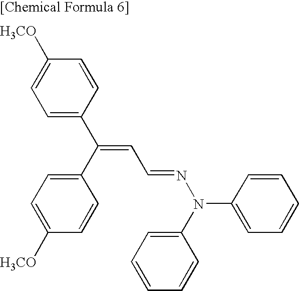

100 parts of a polycarbonate resin having the following repeating structure (viscosity-average molecular weight: about 40000):

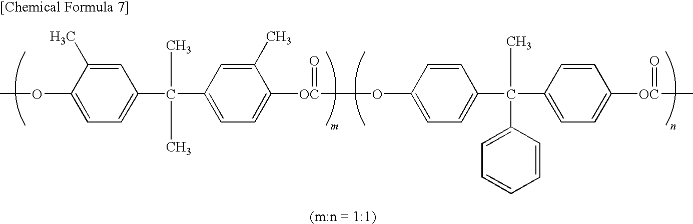

and 0.05 parts by weight of a silicone oil were dissolved in 640 parts by weight of a solvent mixture of tetrahydrofuran/toluene (8/2). The resulting coating liquid for charge-transporting layer was applied onto the charge-generating layer and air-dried for 25 minutes at room temperature to form a charge-transporting layer with a dried thickness of 17 μm.

Drying at 125° C. was further conducted for 20 minutes to give an electrophotographic photoreceptor having the charge-transporting layer. This electrophotographic photoreceptor was used as a photoreceptor P1.

A driving flange was attached to the resulting photoreceptor P1, and these were mounted on a cartridge of a monochrome laser beam printer LBP-850, manufactured by Canon. An image was formed and evaluated by visual inspection. The results are shown in Table 3. In Table 3, regarding interference fringes, black spots, and black lines, “A” denotes that the defects are not observed at all, “B” denotes that the defects are observed at a level that is acceptable for use, and “C” denotes that the defects are observed at a level that is not acceptable for use.

### Example 2

A mirror-finished cut tube (Ra: 0.03, Rz: 0.2) (sic) of an aluminum alloy A6063 defined in JIS H4040 and having an outer diameter of 30 mm, a length of 357 mm, and a thickness of 1.0 mm was subjected to a roughening process using a brush composed of a cylindrical bed of PVC having an outer diameter of 60 mm and being provided with holes having a hole diameter of 5 mm in a zigzag array at 10-mm intervals and a nylon material (“Tynex A”, manufactured by Dupont), containing alumina abrasive grains having a diameter of 0.45 mm and a grain size #500 (average grain diameter: 34 μm), planted in the holes so as to have a length of 25 mm. The roughening was conducted by rotating the substrate at a rotational speed of 200 rpm and rotating the brush at a rotational speed of 750 rpm, with a contact width of 10 mm, a pulling-up speed of 5 mm/sec, and a sprinkling water volume of 1 L/min. The pulling-up speed was set as high as possible within the range that does not cause a low groove density.

Then, the roughened tube was washed by immersing it in a liquid containing 4 wt % degreasing agent, “NG-30”, manufactured by Kizai Co. at 60° C. for 5 minutes. Subsequently, the degreasing agent was removed by immersing the tube in deionized water contained in three vessels at room temperature for 1 minute in each vessel sequentially. Then, the tube was immersed in deionized water at 82° C. for 10 seconds and was pulled up at a speed of 10 mm/sec for a hot water drying. Finally, the tube was subjected to finish drying in a clean oven at 150° C. for 10 minutes and was then spontaneously cooled. As a result, a substrate 2 having a surface provided with curved and discontinuous grooves in an oblique grid pattern, as shown in FIG. 3, was obtained.

Part of the resulting substrate 2 was put aside for measurement of the surface roughness and the groove width. Remaining washed substrate 2 was provided with an undercoat layer and a photosensitive layer as in Example 1 to give a photoreceptor P2.

An image was formed using the resulting photoreceptor P2 as in Example 1 and was evaluated by visual inspection. The results are shown in Table 3.

The substrate 2 put aside was subjected to measurement of the in-plane arithmetic mean roughness Ra, the maximum height surface roughness Rz, and the kurtosis Rku as in Example 1. Furthermore, the maximum value (maximum lateral width) and the minimum value (minimum lateral width) of groove width L of the grooves formed on the surface of the substrate 2 were observed under an optical microscope and measured with a photograph (400 times magnification) of the substrate surface. The results are shown in Table 3.

### Example 3

An ironed tube of an aluminum alloy A3003 defined in JIS H4040 and having an outer diameter of 30 mm, a length of 357 mm, and a thickness of 1.0 mm was subjected to a roughening process as in Example 2 to obtain a substrate 3.

A part of the resulting substrate 3 was put aside for measurement of the surface roughness and the groove width. The remaining washed substrate 3 was provided with a photosensitive layer as in Example 1 to give a photoreceptor P3.

An image was formed using the resulting photoreceptor P3 as in Example 1 and was evaluated by visual inspection. The results are shown in Table 3.

The substrate 3 put aside was subjected to measurement of the in-plane arithmetic mean roughness Ra, the maximum height surface roughness Rz, and the kurtosis Rku as in Example 2. Furthermore, the maximum value (maximum lateral width) and the minimum value (minimum lateral width) of groove width L of the grooves formed on the surface of the substrate 3 were measured. The results are also shown in Table 3.

### Example 4

A ground tube of an aluminum alloy A3003 defined in JIS H4040 and having an outer diameter of 30 mm, a length of 357 mm, and a thickness of 1.0 mm was ground with a centerless grinder so as to have an Rz of 1.0 μm as described in Japanese Unexamined Patent Application Publication No. HEI 7-43922 using a brush material of a nylon material (“Sungrit”, manufactured by Asahi Kasei Corp.) containing alumina abrasive grains having a diameter of 0.3 mm and a grain size #500 (average grain diameter: 34 μm). The roughening process was conducted as in Example 1 by rotating the substrate at a rotational speed of 250 rpm and rotating the brush at a rotational speed of 750 rpm, with a contact width of 6 mm, a pulling-up speed of 5 mm/sec, and a sprinkling water volume of 1 L/min to give a substrate 4 having a surface provided with curved, discontinuous, and oblique grooves as shown in FIG. 3.

A part of the resulting substrate 4 was put aside for measurement of the surface roughness and the groove width. The remaining washed substrate 4 was provided with a photosensitive layer as in Example 1 to give a photoreceptor P4.

An image was formed using the resulting photoreceptor P4 as in Example 1 and was evaluated by visual inspection. The results are shown in Table 3.

The substrate 4 put aside was subjected to measurement of the in-plane arithmetic mean roughness Ra, the maximum height surface roughness Rz, and the kurtosis Rku as in Example 2. Furthermore, the maximum value (maximum lateral width) and the minimum value (minimum lateral width) of groove width L of the grooves formed on the surface of the substrate 4 were measured. The results are also shown in Table 3.

### Example 5

A mirror-finished cut tube (Ra: 0.03 μm, Rz: 0.2 μm) of an aluminum alloy A3003 defined in JIS H4040 and having an outer diameter of 30 mm, a length of 357 mm, and a thickness of 1.0 mm was subjected to dry honing treatment as in the method described in Example 4 of Japanese Unexamined Patent Application Publication No. HEI 5-216261.

This substrate was roughened with a brush material of a nylon material (“Sungrit”, manufactured by Asahi Kasei Corp.) containing alumina abrasive grains having a diameter of 0.3 mm and a grain size #1000 (average grain diameter: 16 μm). The roughening was conducted as in Example 1 by rotating the substrate at a rotational speed of 250 rpm and rotating the brush at a rotational speed of 750 rpm, with a contact width of 6 mm, a pulling-up speed of 10 mm/sec, and a sprinkling water volume of 1 L/min to give a substrate 5 having a surface provided with curved, discontinuous, and oblique grooves as shown in FIG. 3.

A part of the resulting substrate 5 was put aside for measurement of the surface roughness and the groove width. The remaining washed tube was provided with a photosensitive layer as in Example 1 to give a photoreceptor P5.

An image was formed using the resulting photoreceptor P5 as in Example 1 and was evaluated by visual inspection. The results are shown in Table 3.

The substrate 5 put aside was subjected to measurement of the in-plane arithmetic mean roughness Ra, the maximum height surface roughness Rz, and the kurtosis Rku as in Example 2. Furthermore, the maximum value (maximum lateral width) and the minimum value (minimum lateral width) of groove width L of the grooves formed on the surface of the substrate 5 were measured. The results are also shown in Table 3.

### Example 6

An ironed tube of an aluminum alloy A3003 defined in JIS H4040 and having an outer diameter of 30 mm, a length of 357 mm, and a thickness of 1.0 mm was roughened with a brush material of a nylon material (“Sungrit”, manufactured by Asahi Kasei Corp.) containing alumina abrasive grains having a diameter of 0.3 mm and a grain size #1000 (average grain diameter: 16 μm). The roughening process was conducted as in Example 1 by rotating the substrate at a rotational speed of 300 rpm and rotating the brush at a rotational speed of 100 rpm, with a contact width of 4 mm, a pulling-up speed of 1 mm/sec, and a sprinkling water volume of 1 L/min to give a substrate 6 having a surface provided with curved, discontinuous, and oblique grooves as shown in FIG. 2.

A part of the substrate 6 was subjected to measurement of the in-plane arithmetic mean roughness Ra, the maximum height surface roughness Rz, and the kurtosis Rku, as in Example 2, and the maximum value (maximum lateral width) and the minimum value (minimum lateral width) of groove width L of the grooves formed on the surface of the substrate 6 were measured. The results are shown in Table 3.

A coating liquid B for forming an undercoat layer was prepared as in Example 1 except that the dispersion in Ultra Apex Mill was conducted using zirconia beads with a diameter of about 50 μm (YTZ, manufactured by Nikkato Corp.) as a dispersion medium, and subjected to measurement of physical properties as in Example 1. The results are shown in Table 2.

The coating liquid B for forming an undercoat layer was applied onto the substrate 6 by dipping to form an undercoat layer with a dried thickness of 2 μm. The observation of the surface of the undercoat layer with a scanning electron microscope confirmed substantially no agglomeration on the surface.

This undercoat layer (94.2 cm²) was immersed in a solvent mixture of 70 g of methanol and 30 g of 1-propanol and was sonicated with an ultrasonic oscillator at an output of 600 W for 5 minutes to prepare an undercoat layer dispersion. The particle size distribution of the metal oxide particles in the dispersion was measured with the UPA as in Example 1. The volume average particle diameter was 0.09 μm and the 90% cumulative particle diameter was 0.14 μm.

On the undercoat layer, a charge-generating layer and a charge-transporting layer were formed as in Example 1 to give a photoreceptor P6.

The photosensitive layer (94.2 cm²) of this photoreceptor P6 was removed by dissolving the layer in 100 cm³ of tetrahydrofuran by sonication with an ultrasonic oscillator at an output of 600 W for 5 minutes, and then the photoreceptor P6 after the sonication treatment was immersed in a solvent mixture of 70 g of methanol and 30 g of 1-propanol and was sonicated with an ultrasonic oscillator at an output of 600 W for 5 minutes to give an undercoat layer dispersion. The particle size distribution of the metal oxide particles in the dispersion was measured with the UPA as in Example 1. The volume average particle diameter was 0.09 μm and the 90% cumulative particle diameter was 0.14 μm.

An image was formed using the resulting photoreceptor P6 as in Example 1 and was evaluated by visual inspection. The results are shown in Table 3.

### Example 7

A coating liquid C for forming an undercoat layer was prepared as in Example 6 except that the dispersion in Ultra Apex Mill was conducted at a rotor peripheral velocity of 12 m/sec, and was subjected to measurement of physical properties as in Example 1. The results are shown in Table 2.

The coating liquid C for forming an undercoat layer was applied onto the substrate 3 by dipping to form an undercoat layer with a dried thickness of 2 μm. The observation of the surface of the undercoat layer with a scanning electron microscope confirmed substantially no agglomeration on the surface.

On this undercoat layer, a charge-generating layer and a charge-transporting layer were formed as in Example 1 to give a photoreceptor P7.

An image was formed using the resulting photoreceptor P7 as in Example 1 and was evaluated by visual inspection. The results are shown in Table 3.

### Example 8

An ironed tube of an aluminum alloy A3003 defined in JIS H4040 and having an outer diameter of 30 mm, a length of 357 mm, and a thickness of 1.0 mm was roughened with a brush material of a nylon material (“Traygrit”, manufactured by Toray Monofilament Co., Ltd.) containing alumina abrasive grains having a diameter of 0.4 mm and a grain size #800 (average grain diameter: 20 μm). The roughening process was conducted as in Example 1 by rotating the substrate at a rotational speed of 250 rpm and rotating the brush at a rotational speed of 750 rpm, with a contact width of 6 mm, a pulling-up speed of 8 mm/sec, and a sprinkling water volume of 1 L/min to give a substrate 7 having a surface provided with curved, discontinuous, and oblique grooves as shown in FIG. 3.

A part of the substrate 7 was subjected to measurement of the in-plane arithmetic mean roughness Ra, the maximum height surface roughness Rz, and the kurtosis Rku, as in Example 2, and the maximum value (maximum lateral width) and the minimum value (minimum lateral width) of groove width L of the grooves formed on the surface of the substrate 7 were measured. The results are shown in Table 3.

A coating liquid D for forming an undercoat layer was prepared as in Example 7 except that the dispersion in Ultra Apex Mill was conducted using zirconia beads with a diameter of about 30 μm (YTZ, manufactured by Nikkato Corp.) as a dispersion medium, and subjected to measurement of physical properties as in Example 1. The results are shown in Table 2.

The coating liquid D for forming an undercoat layer was applied onto the substrate 7 by dipping to form an undercoat layer with a dried thickness of 2 μm. The observation of the surface of the undercoat layer with a scanning electron microscope confirmed substantially no agglomeration on the surface.

On the undercoat layer, a charge-generating layer and a charge-transporting layer were formed as in Example 1 to give a photoreceptor P8.

An image was formed using the resulting photoreceptor P8 as in Example 1 and was evaluated by visual inspection. The results are shown in Table 3.

### Example 9

An ironed tube of an aluminum alloy A3003 defined in JIS H4040 and having an outer diameter of 30 mm, a length of 357 mm, and a thickness of 1.0 mm was roughened with a brush material of a nylon material (“Sungrit”, manufactured by Asahi Kasei Corp.) containing alumina abrasive grains having a diameter of 0.45 mm and a grain size #500 (average grain diameter: 340 μm). The roughening process was conducted as in Example 1 by rotating the substrate at a rotational speed of 250 rpm and rotating the brush at a rotational speed of 750 rpm, with a contact width of 6 mm, a pulling-up speed of 10 mm/sec, and a sprinkling water volume of 1 L/min to give a substrate 8 having a surface provided with curved, discontinuous, and oblique grooves as shown in FIG. 3.

A part of the substrate 8 was subjected to measurement of the in-plane arithmetic mean roughness Ra, the maximum height surface roughness Rz, and the kurtosis Rku, as in Example 2, and the maximum value (maximum lateral width) and the minimum value (minimum lateral width) of groove width L of the grooves formed on the surface of the substrate 8 were measured. The results are shown in Table 3.

The coating liquid D for forming an undercoat layer was applied onto the substrate 8 by dipping to form an undercoat layer with a dried thickness of 2 μm. The observation of the surface of the undercoat layer with a scanning electron microscope confirmed substantially no agglomeration on the surface.

On the undercoat layer, a charge-generating layer and a charge-transporting layer were formed as in Example 1 to give a photoreceptor P9.

An image was formed using the resulting photoreceptor P9 as in Example 1 and was evaluated by visual inspection. The results are shown in Table 3.

### Example 10

A substrate of an aluminum alloy A3003 defined in JIS H4040 and having an outer diameter of 30 mm, a length of 346 mm, and a thickness of 1.0 mm was roughened as in Example 2 to give a substrate 9.

A part of this substrate 9 was subjected to measurement of the in-plane arithmetic mean roughness Ra, the maximum height surface roughness Rz, and the kurtosis Rku, as in Example 2, and the maximum value (maximum lateral width) and the minimum value (minimum lateral width) of groove width L of the grooves formed on the surface of the substrate 9 were measured. The results are shown in Table 3.

The coating liquid D for forming an undercoat layer was applied onto the substrate 9 by dipping to form an undercoat layer with a dried thickness of 2 μm. The observation of the surface of the undercoat layer with a scanning electron microscope confirmed substantially no agglomeration on the surface.

Then, 60 parts of a composition (A), produced by the process described in Example 1 of Japanese Unexamined Patent Application Publication No. 2002-080432, mainly having a structure represented by the following formula as a charge-transporting material:

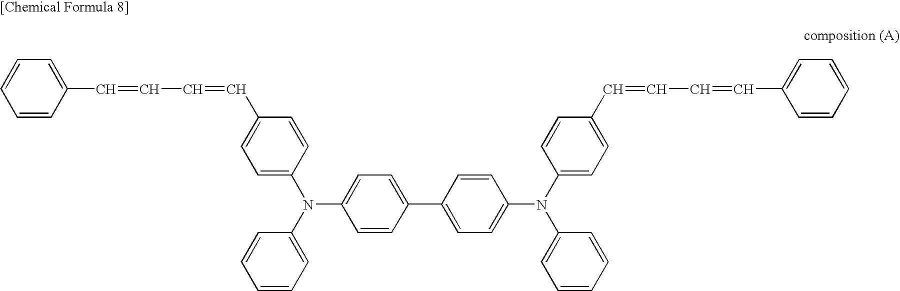

100 parts of a polycarbonate resin having the following repeating structure (viscosity-average molecular weight: about 30000):

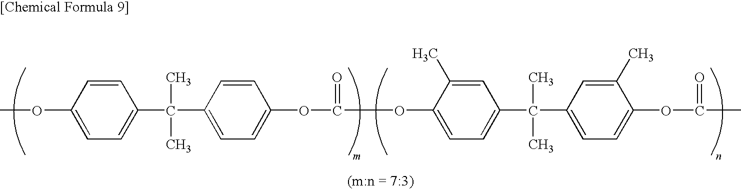

and 0.05 part by weight of a silicone oil were dissolved in 640 parts by weight of a solvent mixture of tetrahydrofuran/toluene (8/2). The resulting coating liquid was applied onto the charge-generating layer to form a charge-transporting layer with a dried thickness of 10 μm for producing an electrophotographic photoreceptor P10.

The resulting photoreceptor P10 was mounted on a cartridge (an integrated cartridge consisting of dual-component toner, a scorotron charging member, and a blade cleaning member) of a copier (product name: Workio DP1820, manufactured by Panasonic Communications Co., Ltd.), and an image was formed with this. The image was satisfactory.

### Example 11

A substrate 10 was produced as in Example 10 except that the pulling-up speed was 1.3 mm/sec.

A part of the substrate 10 was subjected to measurement of the in-plane arithmetic mean roughness Ra, the maximum height surface roughness Rz, and the kurtosis Rku, as in Example 2, and the maximum value (maximum lateral width) and the minimum value (minimum lateral width) of groove width L of the grooves formed on the surface of the substrate 10 were measured. The results are shown in Table 3.

The substrate 10 was provided with a photosensitive layer as in Example 10 to give a photoreceptor P11.

The resulting photoreceptor P11 was mounted on a cartridge of a copier (product name: Workio DP1820, manufactured by Panasonic Communications Co., Ltd.), and an image was formed with this. The image was satisfactory.

### Example 12

An ironed tube of an aluminum alloy A3003 defined in JIS H4040 and having an outer diameter of 30 mm, a length of 388 mm, and a thickness of 0.75 mm was roughened as in Example 2 to give a substrate 11 having a surface provided with curved, discontinuous, and oblique grooves as shown in FIG. 3.

A part of this substrate 11 was subjected to measurement of the in-plane arithmetic mean roughness Ra, the maximum height surface roughness Rz, and the kurtosis Rku, as in Example 2, and the maximum value (maximum lateral width) and the minimum value (minimum lateral width) of groove width L of the grooves formed on the surface of the substrate 11 were measured. The results are shown in Table 3.

A coating liquid E for forming an undercoat layer was prepared as in Example 2 except that the weight ratio of surface-treated titanium oxide/copolymerized polyamide was 2/1. The physical properties of this coating liquid E for forming an undercoat layer were measured as in Example 1. The results are shown in Table 2.

The coating liquid E for forming an undercoat layer was applied onto the substrate 11 by dipping to form an undercoat layer with a dried thickness of 2 μm. The observation of the surface of the undercoat layer with a scanning electron microscope confirmed substantially no agglomeration on the surface.

On the undercoat layer, a charge-generating layer and a charge-transporting layer were formed as in Example 10 to give a photoreceptor P12.

The resulting photoreceptor was mounted on a cartridge (an integrated cartridge consisting of two-component toner, a contact-type charging roller member, and a blade cleaning member) of a copier (product name: Workio C262, manufactured by Panasonic Communications Co., Ltd.), and an image was formed with this. The image was satisfactory.

### Example 13

An ironed tube of an aluminum alloy A3003 defined in JIS H4040 and having an outer diameter of 30 mm, a length of 388 mm, and a thickness of 0.75 mm was roughened as in Example 11 to give a substrate 12 having a surface provided with curved, discontinuous, and oblique grooves as shown in FIG. 3.

A part of this substrate 12 was subjected to measurement of the in-plane arithmetic mean roughness Ra, the maximum height surface roughness Rz, and the kurtosis Rku, as in Example 2, and the maximum value (maximum lateral width) and the minimum value (minimum lateral width) of groove width L of the grooves formed on the surface of the substrate 12 were measured. The results are shown in Table 3.

On the substrate 12, a charge-generating layer and a charge-transporting layer were formed as in Example 12 to give a photoreceptor P13.

The resulting photoreceptor was mounted on a cartridge of a copier (product name: Workio C262, manufactured by Panasonic Communications Co., Ltd.), and an image was formed with this. The image was satisfactory.

### Comparative Example 1

A substrate 13 made of an aluminum alloy A6063 defined in JIS H4040 and having an outer diameter of 30 mm, a length of 357 mm, and a thickness of 1.0 mm was provided with a maximum height surface roughness Rz of 0.6 μm on the surface thereof by cutting with a polycrystalline diamond bit.

A part of the substrate 13 was used for measurement of the in-plane arithmetic mean roughness Ra, the maximum height surface roughness Rz, and the kurtosis Rku of the substrate 13. The results are shown in Table 3.

On the substrate 13, a photosensitive layer was formed as in Example 1 to give a photoreceptor P14.

An image was formed using the resulting photoreceptor P14 as in Example 1 and was evaluated by visual inspection. The results are shown in Table 3.

### Comparative Example 2

A coating liquid F for forming an undercoat layer was prepared with a dispersion slurry liquid that was prepared by dispersing a mixture of 50 parts of surface-treated titanium oxide and 120 parts of methanol in a ball mill using alumina balls (HD, manufactured by Nikkato Corp.) having a diameter of about 5 mm for 5 hours as in Example 1 except that dispersion using Ultra Apex Mill was not carried out.

The physical properties of this coating liquid F for forming an undercoat layer were measured as in Example 1. The results are shown in Table 2.

The coating liquid F for forming an undercoat layer was applied onto the substrate 1 by dipping to form an undercoat layer with a dried thickness of 1.5 The observation of the surface of the undercoat layer with a scanning electron microscope confirmed agglomeration on the surface.

On this undercoat layer, a charge-generating layer and a charge-transporting layer were formed as in Example 1 to give a photoreceptor P15.

An image was formed using the resulting photoreceptor P15 as in Example 1 and was evaluated by visual inspection. The results are shown in Table 3.

### Comparative Example 3

An ironed tube of an aluminum alloy A3003 defined in JIS H4040 and having an outer diameter of 30 mm, a length of 357 mm, and a thickness of 1.0 mm was roughened with a brush material of a nylon material (“Sungrit”, manufactured by Asahi Kasei Corp.) containing alumina abrasive grains having a diameter of 0.3 mm and a grain size #1000 (average grain diameter: 16 μm). The roughening process was conducted as in Example 2 by rotating the substrate at a rotational speed of 200 rpm and rotating the brush at a rotational speed of 750 rpm, with a contact width of 10 mm, a pulling-up speed of 5 mm/sec, and a sprinkling water volume of 1 L/min to give a substrate 14 provided with curved, discontinuous, and oblique grooves.

A part of this substrate 14 was subjected to measurement of the in-plane arithmetic mean roughness Ra, the maximum height surface roughness Rz, and the kurtosis Rku, as in Example 2, and the maximum value (maximum lateral width) and the minimum value (minimum lateral width) of groove width L of the grooves formed on the surface of the substrate 14 were measured. The results are shown in Table 3.

On the substrate 14, a photosensitive layer was formed as in Example 1 to give a photoreceptor P16.

An image was formed using the resulting photoreceptor P16 as in Example 1 and was evaluated by visual inspection. The results are shown in Table 3.

### Comparative Example 4

On the substrate 3, a photosensitive layer was formed as in Comparative Example 2 to give a photoreceptor P17.

An image was formed using the resulting photoreceptor P17 as in Example 1 and was evaluated by visual inspection. The results are shown in Table 3.

### Comparative Example 5

A substrate of an aluminum alloy A3003 defined in JIS H4040 and having an outer diameter of 30 mm, a length of 346 mm, and a thickness of 1.0 mm was roughened as in Example 8 to give a substrate 15.

A part of this substrate 15 was subjected to measurement of the in-plane arithmetic mean roughness Ra, the maximum height surface roughness Rz, and the kurtosis Rku, as in Example 2, and the maximum value (maximum lateral width) and the minimum value (minimum lateral width) of groove width L of the grooves formed on the surface of the substrate 15 were measured. The results are shown in Table 3.

On the substrate 15, a photosensitive layer was formed as in Example 10 to give a photoreceptor P18.

The resulting photoreceptor was mounted on a cartridge of a copier (product name: Workio DP1820, manufactured by Panasonic Communications Co., Ltd.), and an image was formed with this. The image was satisfactory.

### Comparative Example 6

An ironed tube of an aluminum alloy A3003 defined in JIS H4040 and having an outer diameter of 30 mm, a length of 388 mm, and a thickness of 0.75 mm was roughened as in Example 8 to give a substrate 16.

A part of this substrate 16 was subjected to measurement of the in-plane arithmetic mean roughness Ra, the maximum height surface roughness Rz, and the kurtosis Rku, as in Example 2, and the maximum value (maximum lateral width) and the minimum value (minimum lateral width) of groove width L of the grooves formed on the surface of the substrate 16 were measured. The results are shown in Table 3.

On the substrate 16, a photosensitive layer was formed as in Example 12 to give a photoreceptor P19.

The resulting photoreceptor P19 was mounted on a cartridge of a copier (product name: Workio C262, manufactured by Panasonic Communications Co., Ltd.), and an image was formed with this. The image was satisfactory.

### Comparative Example 7

A substrate 17 of an aluminum alloy A6063 defined in JIS H4040 and having an outer diameter of 30 mm, a length of 357 mm, and a thickness of 1.0 mm was provided with a maximum height surface roughness Rz of 1.4 μm on the surface thereof by cutting with a polycrystalline diamond bit.

A part of the substrate 17 was used for measurement of the in-plane arithmetic mean roughness Ra, the maximum height surface roughness Rz, and the kurtosis Rku of the substrate 17, as in Example 1. The results are shown in Table 3.

On the substrate 17, a photosensitive layer was formed as in Example 1 to give a photoreceptor P20.

An image was formed using the resulting photoreceptor P20 as in Example 1 and was evaluated by visual inspection. The results are shown in Table 3.

### Comparative Example 8

An ironed tube of an aluminum alloy A3003 defined in JIS H4040 and having an outer diameter of 30 mm, a length of 346 mm, and a thickness of 1.0 mm was roughened with a brush material of a nylon material (“Tynex A”, manufactured by Dupont) containing alumina abrasive grains having a diameter of 0.55 mm and a grain size #500 (average grain diameter: 34 μm). The roughening process was conducted as in Example 2 by rotating the substrate at a rotational speed of 250 rpm and rotating the brush at a rotational speed of 750 rpm, with a contact width of 6 mm, a pulling-up speed of 1.3 mm/sec, and a sprinkling water volume of 1 L/min to give a substrate 18 having a surface provided with curved, discontinuous, and oblique grooves.

A part of the substrate 18 was used for measurement of the in-plane arithmetic mean roughness Ra, the maximum height surface roughness Rz, and the kurtosis Rku of the substrate 18, as in Example 2, and the maximum value (maximum lateral width) and the minimum value (minimum lateral width) of groove width L of the grooves formed on the surface of the substrate 18 were measured. The results are shown in Table 3.

On the substrate 18, a photosensitive layer was formed as in Example 10 to give a photoreceptor P21.

The resulting photoreceptor P21 was mounted on a cartridge of a copier (product name: Workio DP1820, manufactured by Panasonic Communications Co., Ltd.), and an image was formed with this. The image was satisfactory.

TABLE 2
[Physical properties of coating liquid for forming
undercoat layer]

| | | | | Rotor | Volume average | 90% Cumulative |
|---|---|---|---|---|---|---|
| | Coating | | Medium | peripheral | particle diameter | particle diameter |
| | liquid | Medium | diameter | velocity | (μm) | (μm) |
| Example 1 | A | Zirconia | 100 μm | 10 m/s | 0.09 | 0.13 |
| Example 6 | B | Zirconia | 50 μm | 10 m/s | 0.08 | 0.12 |
| Example 7 | C | Zirconia | 50 μm | 12 m/s | 0.08 | 0.11 |
| Example 8 | D | Zirconia | 30 μm | 12 m/s | 0.07 | 0.10 |
| Example 12 | E | Zirconia | 100 μm | 10 m/s | 0.07 | 0.11 |
| Comparative | F | Alumina | 5 mm | — | 0.13 | 0.21 |
| Example 2 | | | | | | |

—: Not applicable or not measured

TABLE 3

| | | | | | Minimum | Maximum | | | |
|---|---|---|---|---|---|---|---|---|---|
| | | Ra | Rz | Rku | lateral width | lateral width | Interference | Black | Black |
| | Substrate | (μm) | (μm) | (μm) | (μm) | (μm) | fringe | spot | line |
| Example 1 | Substrate 1 | 0.15 | 1.30 | 2.8 | — | — | A | A | A |
| Example 2 | Substrate 2 | 0.14 | 1.01 | 8.0 | 0.7 | 3.7 | A | A | A |
| Example 3 | Substrate 3 | 0.15 | 1.57 | 6.2 | 0.8 | 4.2 | A | A | A |
| Example 4 | Substrate 4 | 0.15 | 1.12 | 9.5 | 0.6 | 5.5 | A | A | A |
| Example 5 | Substrate 5 | 0.17 | 1.66 | 6.5 | 0.7 | 4.7 | A | A | A |
| Example 6 | Substrate 6 | 0.10 | 0.81 | 21 | 0.5 | 1.9 | A | A | A |
| Example 7 | Substrate 3 | 0.15 | 1.57 | 6.2 | 0.8 | 4.2 | A | A | A |
| Example 8 | Substrate 7 | 0.12 | 1.16 | 8.2 | 0.8 | 3.8 | A | A | A |
| Example 9 | Substrate 8 | 0.17 | 1.64 | 6.3 | 1.1 | 4.8 | A | A | A |
| Example 10 | Substrate 9 | 0.15 | 1.57 | 6.2 | 0.8 | 4.2 | A | A | A |
| Example 11 | Substrate 10 | 0.17 | 1.82 | 4.3 | 0.8 | 3.9 | A | A | A |
| Example 12 | Substrate 11 | 0.15 | 1.57 | 6.2 | 0.8 | 4.2 | A | A | A |
| Example 13 | Substrate 12 | 0.17 | 1.82 | 4.3 | 0.8 | 3.9 | A | A | A |
| Comparative | Substrate 13 | 0.07 | 0.6 | 2.6 | — | — | C | A | A |
| Example 1 | | | | | | | | | |
| Comparative | Substrate 1 | 0.15 | 1.3 | 2.8 | — | — | A | C | A |
| Example 2 | | | | | | | | | |
| Comparative | Substrate 14 | 0.10 | 0.69 | 8.2 | 0.5 | 1.5 | B | A | A |
| Example 3 | | | | | | | | | |
| Comparative | Substrate 3 | 0.15 | 1.57 | 6.2 | 0.8 | 4.2 | A | C | A |
| Example 4 | | | | | | | | | |
| Comparative | Substrate 15 | 0.1 | 0.69 | 8.2 | 0.5 | 1.5 | C | A | A |
| Example 5 | | | | | | | | | |
| Comparative | Substrate 16 | 0.10 | 0.69 | 8.2 | 0.5 | 1.5 | B | A | A |
| Example 6 | | | | | | | | | |
| Comparative | Substrate 17 | 0.15 | 1.42 | 2.7 | — | — | A | A | B |
| Example 7 | | | | | | | | | |
| Comparative | Substrate 18 | 0.25 | 2.8 | 3.3 | 1.3 | 8 | A | B | B |
| Example 8 | | | | | | | | | |

—: Not applicable or not measured

### INDUSTRIAL APPLICABILITY

The present invention can be applied to any industrial field, in particular, can be preferably applied to, for example, printers, facsimile machines, and copiers of electrophotographic systems.

Although the present invention has been described in detail with reference to certain preferred embodiments, those skilled in the art will recognize that various modifications will be made without departing from the purpose and scope of the present invention.

The present application is based on Japanese Patent Application (Patent Application No. 2006-139528) filed on May 18, 2006, the entire contents of which are hereby incorporated by reference.

1. An electrophotographic photoreceptor comprising an undercoat layer containing metal oxide particles and a binder resin on an electroconductive substrate having a maximum height surface roughness Rz in the range of 0.8≦Rz≦2 μm, and a photosensitive layer disposed on the undercoat layer, wherein
the metal oxide particles have a volume average particle diameter of 0.1 μm or less and a 90% cumulative particle diameter of 0.3 μm or less which are measured by a dynamic light-scattering method in a liquid containing the undercoat layer dispersed in a solvent mixture of methanol and 1-propanol at a weight ratio of 7:3.

2. The electrophotographic photoreceptor according to claim 1, wherein
the surface profile of the electroconductive substrate is formed by a cutting process.

3. The electrophotographic photoreceptor according to claim 1, wherein
the surface of the electroconductive substrate is provided with micro-grooves, wherein
the shapes of the grooves are curved and discontinuous in a developed plan view of the electroconductive substrate surface.

4. The electrophotographic photoreceptor according to claim 3, wherein
the grooves provided on the surface of the electroconductive substrate have a grid pattern.

5. The electrophotographic photoreceptor according to claim 3, wherein
the surface of the electroconductive substrate has a kurtosis Rku in the range of 3.5≦Rku≦25; and
the grooves provided on the surface of the electroconductive substrate has a groove width L of 0.5≦L≦6.0 μm.

6. A process of producing an electroconductive substrate employed in an electrophotographic photoreceptor according to claim 1 comprising:
bringing a flexible material into contact with a surface of the electroconductive substrate and moving the flexible material relative to the electroconductive substrate surface.

7. The process of producing an electroconductive substrate according to claim 6, wherein
the surface of the electroconductive substrate is preliminarily processed by cutting.

8. The process of producing an electroconductive substrate according to claim 6, wherein
the surface of the electroconductive substrate is preliminarily processed by ironing.

9. The process of producing an electroconductive substrate according to claim 6, wherein
the surface of the electroconductive substrate is preliminarily processed by grinding.

10. The process of producing an electroconductive substrate according to claim 6, wherein
the surface of the electroconductive substrate is preliminarily processed by honing.

11. The process of producing an electroconductive substrate according to claim 6, wherein
the flexible material is a brush.

12. The process of producing an electroconductive substrate according to claim 11, wherein
the brush comprises a resin containing abrasive grains kneaded therein.

13. An image-forming apparatus comprising:
an electrophotographic photoreceptor according to claim 1;
charging means for charging the electrophotographic photoreceptor;
image exposing means for forming an electrostatic latent image by conducting image exposure to the charged electrophotographic photoreceptor;
development means for developing the electrostatic latent image with toner; and
transfer means for transferring the toner to a transfer object.

14. An electrophotographic cartridge comprising:
an electrophotographic photoreceptor according to claim 1; and
at least one means selected from charging means for charging the electrophotographic photoreceptor, image exposing means for forming an electrostatic latent image by conducting image exposure to the charged electrophotographic photoreceptor, development means for developing the electrostatic latent image with toner, transfer means for transferring the toner to a transfer object, fixing means for fixing the toner transferred to the transfer object, and cleaning means for recovering the toner adhering to the electrophotographic photoreceptor.
